(19) United States
(12) Patent Application Publication
(10) Pub. No.: US 2006/0242562 A1
(43) Pub. Date: Oct. 26, 2006

(54) Embedded method for embedded interaction code array

(75) Inventors: Jian Wang, Beijing (CN); Yingnong Dang, Beijing (CN); Qiang Wang, Beijing (CN); Jiang Wu, San Jose, CA (US); Zhouchen Lin, Beijing (CN)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/112,831

(22) Filed: Apr. 22, 2005

(51) Int. Cl. G06F 17/00

(52) U.S. Cl. 715/513

(57) ABSTRACT

Embodiments of the invention configure and analyze an embedded interaction code (EIC) array of an EIC document. An EIC font, having a selected geometric shape, is configured so that a generated EIC symbol encodes EIC data. The EIC font is configured with at least one orientation dot so that a captured image can be properly orientated. An EIC document system is configured to support a desired address space of an EIC array, a desired decoding performance, and a desired level of readability of an EIC document. An EIC font is configured to include a plurality of data dots along an edge. The selection of the EIC font takes into consideration a number of dimensions and the order of a constituent m-array, which is associated with one of the dimensions. An EIC font may be configured with at least one clock dot to support segmenting EIC symbols in the captured image.

### TECHNICAL FIELD

The present invention relates to embedding an embedded interaction code (EIC) into a document. More particularly, the present invention relates to configuring an EIC font in accordance with intended parameters of an EIC document system.

### BACKGROUND

Computer users are accustomed to using a mouse and keyboard as a way of interacting with a personal computer. While personal computers provide a number of advantages over written documents, most users continue to perform certain functions using printed paper. Some of these functions include reading and annotating written documents. In the case of annotations, the printed document assumes a greater significance because of the annotations placed on it by the user. One of the difficulties, however, with having a printed document with annotations is the later need to have the annotations entered back into the electronic form of the document. This requires the original user or another user to wade through the annotations and enter them into a personal computer. In some cases, a user will scan in the annotations and the original text, thereby creating a new document. These multiple steps make the interaction between the printed document and the electronic version of the document difficult to handle on a repeated basis. Further, scanned-in images are frequently non-modifiable. There may be no way to separate the annotations from the original text. This makes using the annotations difficult. Accordingly, an improved way of handling annotations is needed.

One technique of capturing handwritten information is by using a pen whose location may be determined during writing. One pen that provides this capability is the Anoto pen by Anoto Inc. This pen functions by using a camera to capture an image of paper encoded with a predefined pattern. An example of the image pattern is shown in FIG. 11. This pattern is used by the Anoto pen (by Anoto Inc.) to determine a location of a pen on a piece of paper. However, it is unclear how efficient the determination of the location is with the system used by the Anoto pen. To provide an efficient determination of the captured image's location, a system is needed that provides an efficient approach to configuring a maze pattern for identifying the location of the pen in relation to a document.

### SUMMARY

Aspects of the present invention provide solutions to at least one of the issues mentioned above, thereby enabling one to configure a maze pattern to locate a position or positions of the captured image on a viewed document. The viewed document may be on paper, LCD screen, or any other medium with the predefined pattern. Aspects of the present invention include configuring an embedded interaction code (EIC) font that encodes EIC data and orientates an EIC symbol.

With one aspect of the invention, an embedded interaction code (EIC) document system is configured in order to support a desired address space of an EIC array, a desired decoding performance, and a desired level of readability of an EIC document.

With another aspect of the invention, an EIC font is configured to include a plurality of data dots along an edge. An EIC pattern that includes EIC symbols are formed from the selected EIC font. An EIC symbol is generated using the EIC font by encoding information bits within the EIC symbol. In order to encode a desired number of data bits, data dots are marked to represent the encoded data bits.

With another aspect of the invention, a geometric shape is selected for an EIC font. The selection considers a number of dimensions and the order to a constituent m-array, which is associated with one of the dimensions.

With another aspect of the invention, an EIC font is configured with at least one clock dot to support segmenting EIC symbols that are captured by a pen camera.

With another aspect of the invention, an EIC font is configured with at least one parity dot. An EIC symbol is generated in which the at least one parity dot is marked to provide an indication of either even or odd parity.

With another aspect of the invention, an EIC font is configured with at least one orientation dot. The at least one orientation dot is not marked so that a captured image can be properly orientated.

With another aspect of the invention, an EIC symbol is extracted from a captured image using orientation dots contained in each EIC symbol.

These and other aspects of the present invention will become known through the following drawings and associated description.

### BRIEF DESCRIPTION OF DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 shows a general description of a computer that may be used in conjunction with embodiments of the present invention.

FIGS. 2A and 2B show an image capture system and corresponding captured image in accordance with embodiments of the present invention.

FIGS. 3A through 3F show various sequences and folding techniques in accordance with embodiments of the present invention.

FIGS. 4A through 4E show various encoding systems in accordance with embodiments of the present invention.

FIGS. 5A through 5D show four possible resultant corners associated with the encoding system according to FIGS. 4A and 4B.

FIG. 6 shows rotation of a captured image portion in accordance with embodiments of the present invention.

FIG. 7 shows various angles of rotation used in conjunction with the coding system of FIGS. 4A through 4E.

FIG. 8 shows a process for determining the location of a captured array in accordance with embodiments of the present invention.

FIG. 9 shows a method for determining the location of a captured image in accordance with embodiments of the present invention.

FIG. 10 shows another method for determining the location of captured image in accordance with embodiments of the present invention.

FIG. 11 shows a representation of encoding space in a document according to prior art.

FIG. 12 shows a flow diagram for decoding extracted bits from a captured image in accordance with embodiments of the present invention.

FIG. 13A shows a one-dimensional embedded interaction code (EIC) according to an embodiment of the present invention.

FIG. 13B shows an eight-dimensional EIC according to an embodiment of the present invention.

FIG. 14 shows an EIC font that represents one information bit according to an embodiment of the present invention.

FIG. 15 shows an EIC font that represents one information bit according to an embodiment of the present invention.

FIG. 16 shows a coordinate system of an EIC symbol according to an embodiment of the present invention.

FIG. 17 shows an EIC pattern representing an EIC array with an EIC font as shown in FIG. 14.

FIG. 18 shows an EIC pattern representing an EIC array with an EIC font as shown in FIG. 19.

FIG. 19 shows an EIC font that encodes one information bit according to an embodiment of the present invention.

FIG. 20 shows a rectangle and a diamond EIC pattern structure according to an embodiment of the present invention.

FIG. 21 shows a triangle and a hexagonal EIC pattern structure according to an embodiment of the present invention.

FIG. 22 shows a visual representation of two information bits according to an embodiment of the present invention.

FIG. 23 shows different orientations of a captured image according to an embodiment of the present invention.

FIG. 24 shows different orientations of an EIC pattern in accordance with an embodiment of the present invention.

FIG. 25 shows an EIC font in accordance with an embodiment of the present invention.

FIG. 26 shows different orientations of the EIC font shown in FIG. 25.

FIG. 27 shows different offsets of a diamond shaped EIC pattern in accordance with an embodiment of the present invention.

FIG. 28 shows a diamond shaped EIC font in accordance with an embodiment of the present invention.

FIG. 29 shows different orientations of the EIC font shown in FIG. 28.

FIG. 30 shows different EIC fonts that encode one information bit according to an embodiment of the present invention.

FIG. 31 shows corresponding EIC patterns for the EIC fonts shown in FIG. 30.

FIG. 32 shows different EIC fonts that encode two information bits according to an embodiment of the present invention.

FIG. 33 shows corresponding EIC patterns for the EIC fonts shown in FIG. 32.

FIG. 34 shows different EIC fonts that encode four information bits according to an embodiment of the present invention.

FIG. 35 shows corresponding EIC patterns for the EIC fonts shown in FIG. 34.

FIG. 36 shows a diamond shaped EIC font that encodes eight information bits according to an embodiment of the present invention.

FIG. 37 shows a diamond shaped EIC font that encodes eight information bits with a parity bit according to an embodiment of the present invention.

FIG. 38 shows corresponding EIC patterns for the EIC fonts shown in FIG. 36 and 37.

FIG. 39 shows a triangle shaped EIC font that encodes three information bits according to an embodiment of the present invention.

FIG. 40 shows the corresponding EIC pattern for the EIC font shown in FIG. 39.

FIG. 41 shows a flow diagram for designing an EIC document system in accordance with an embodiment of the invention.

FIG. 42 shows a process for designing an EIC font in accordance with an embodiment of the invention.

### DETAILED DESCRIPTION

Aspects of the present invention relate to determining the location of a captured image in relation to a larger image. The location determination method and system described herein may be used in combination with a multi-function pen.

The following is separated by subheadings for the benefit of the reader. The subheadings include: terms, general-purpose computer, image capturing pen, encoding of array, decoding, error correction, location determination, and maze pattern analysis.

Terms

Pen—any writing implement that may or may not include the ability to store ink. In some examples, a stylus with no ink capability may be used as a pen in accordance with embodiments of the present invention.

Camera—an image capture system that captures an image from paper or any other medium.

General Purpose Computer

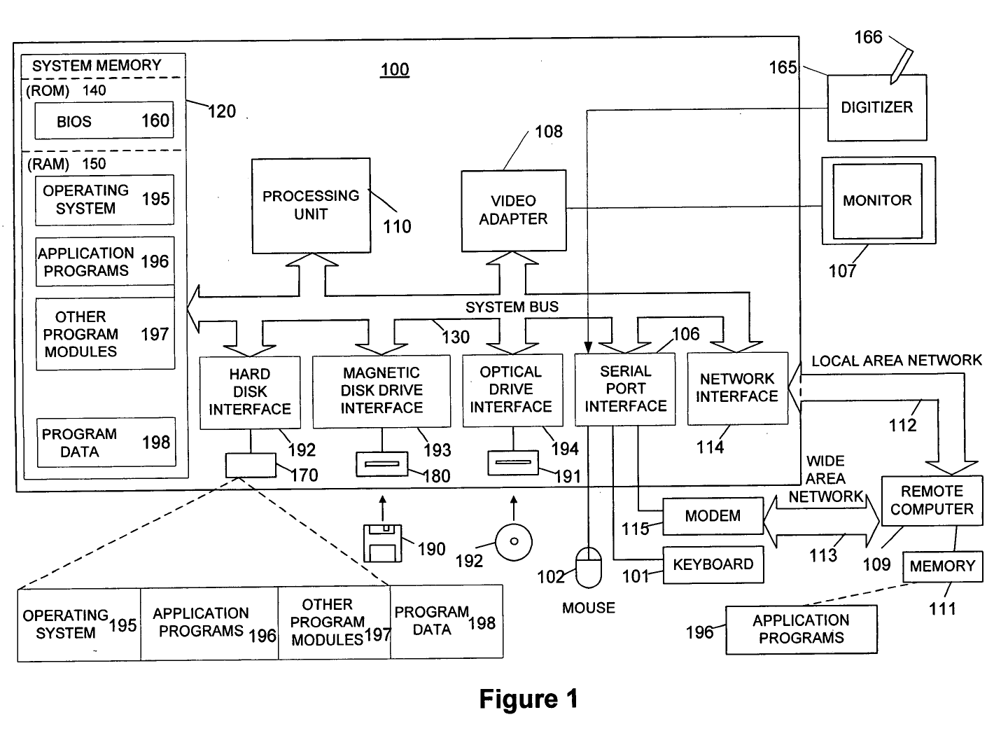

FIG. 1 is a functional block diagram of an example of a conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a preferred embodiment, a pen digitizer 165 and accompanying pen or stylus 166 are provided in order to digitally capture freehand input. Although a direct connection between the pen digitizer 165 and the serial port is shown, in practice, the pen digitizer 165 may be coupled to the processing unit 110 directly, via a parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

Image Capturing Pen

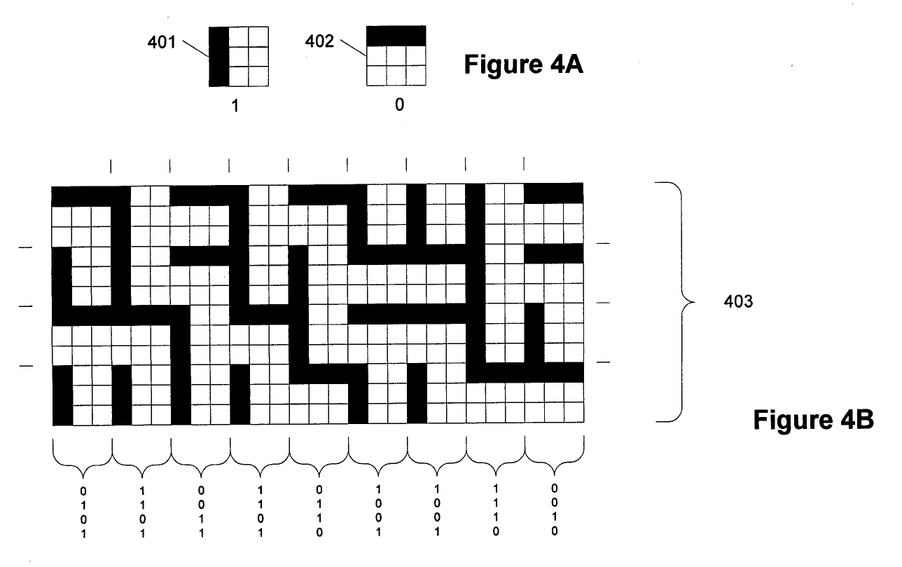

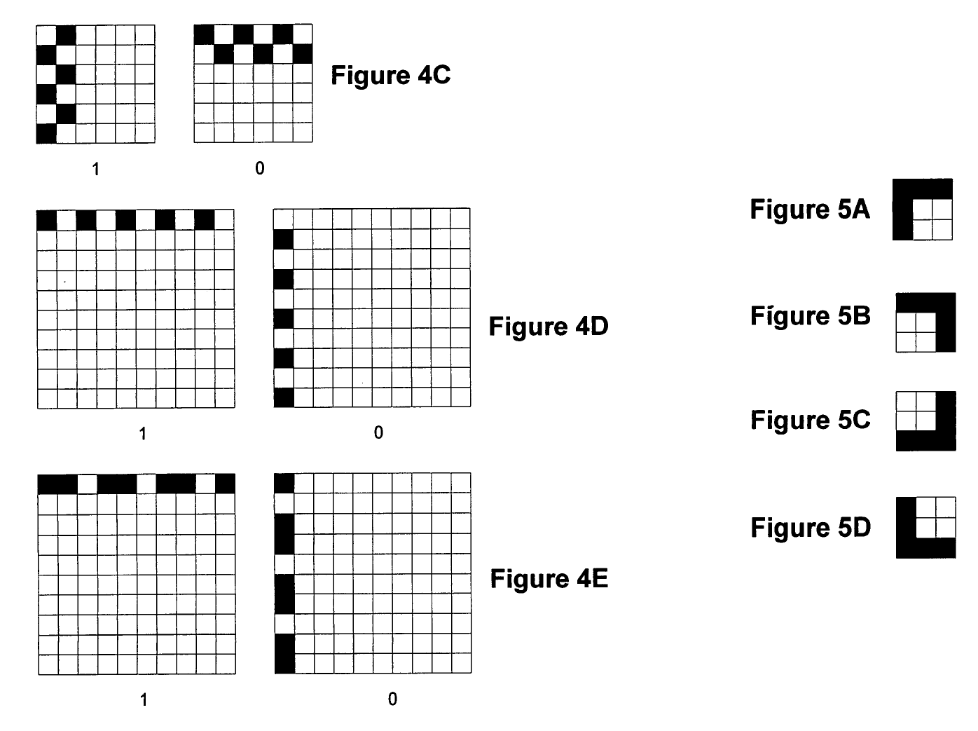

Aspects of the present invention include placing an encoded data stream in a displayed form that represents the encoded data stream. (For example, as will be discussed with FIG. 4B, the encoded data stream is used to create a graphical pattern.) The displayed form may be printed paper (or other physical medium) or may be a display projecting the encoded data stream in conjunction with another image or set of images. For example, the encoded data stream may be represented as a physical graphical image on the paper or a graphical image overlying the displayed image (e.g., representing the text of a document) or may be a physical (non-modifiable) graphical image on a display screen (so any image portion captured by a pen is locatable on the display screen).

This determination of the location of a captured image may be used to determine the location of a user's interaction with the paper, medium, or display screen. In some aspects of the present invention, the pen may be an ink pen writing on paper. In other aspects, the pen may be a stylus with the user writing on the surface of a computer display. Any interaction may be provided back to the system with knowledge of the encoded image on the document or supporting the document displayed on the computer screen. By repeatedly capturing images with a camera in the pen or stylus as the pen or stylus traverses a document, the system can track movement of the stylus being controlled by the user. The displayed or printed image may be a watermark associated with the blank or content-rich paper or may be a watermark associated with a displayed image or a fixed coding overlying a screen or built into a screen.

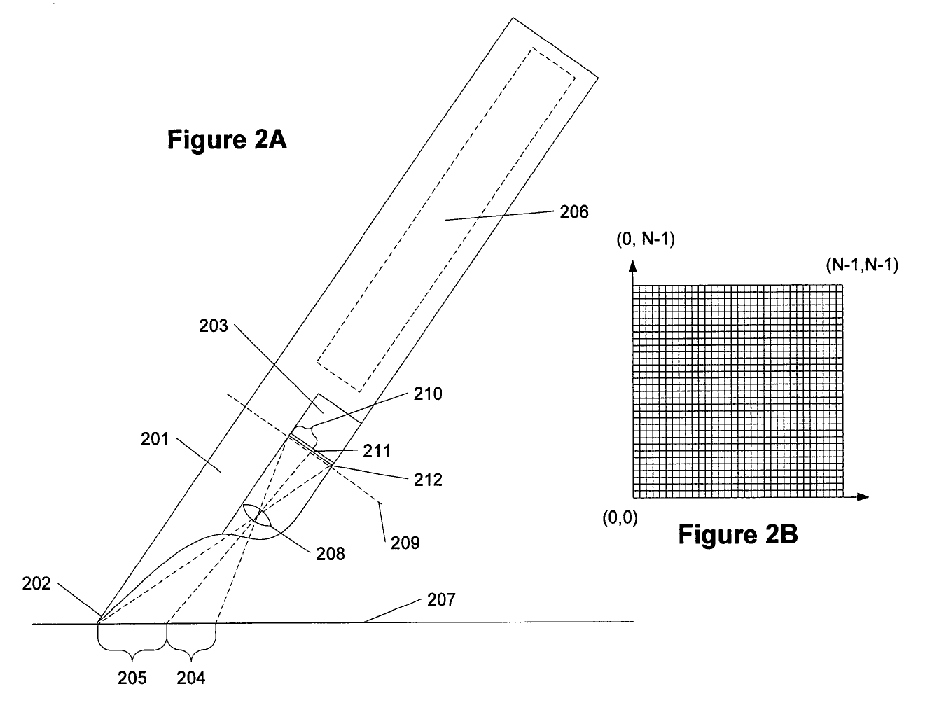

FIGS. 2A and 2B show an illustrative example of pen 201 with a camera 203. Pen 201 includes a tip 202 that may or may not include an ink reservoir. Camera 203 captures an image 204 from surface 207. Pen 201 may further include additional sensors and/or processors as represented in broken box 206. These sensors and/or processors 206 may also include the ability to transmit information to another pen 201 and/or a personal computer (for example, via Bluetooth or other wireless protocols).

FIG. 2B represents an image as viewed by camera 203. In one illustrative example, the field of view of camera 203 (i.e., the resolution of the image sensor of the camera) is 32×32 pixels (where N=32). In the embodiment, a captured image (32 pixels by 32 pixels) corresponds to an area of approximately 5 mm by 5 mm of the surface plane captured by camera 203. Accordingly, FIG. 2B shows a field of view of 32 pixels long by 32 pixels wide. The size of N is adjustable, such that a larger N corresponds to a higher image resolution. Also, while the field of view of the camera 203 is shown as a square for illustrative purposes here, the field of view may include other shapes as is known in the art.

The images captured by camera 203 may be defined as a sequence of image frames {Iᵢ}, where Iᵢ is captured by the pen 201 at sampling time tᵢ. The sampling rate may be large or small, depending on system configuration and performance requirement. The size of the captured image frame may be large or small, depending on system configuration and performance requirement.

The image captured by camera 203 may be used directly by the processing system or may undergo pre-filtering. This pre-filtering may occur in pen 201 or may occur outside of pen 201 (for example, in a personal computer).

The image size of FIG. 2B is 32×32 pixels. If each encoding unit size is 3×3 pixels, then the number of captured encoded units would be approximately 100 units. If the encoding unit size is 5×5 pixels, then the number of captured encoded units is approximately 36.

FIG. 2A also shows the image plane 209 on which an image 210 of the pattern from location 204 is formed. Light received from the pattern on the object plane 207 is focused by lens 208. Lens 208 may be a single lens or a multi-part lens system, but is represented here as a single lens for simplicity. Image capturing sensor 211 captures the image 210.

The image sensor 211 may be large enough to capture the image 210. Alternatively, the image sensor 211 may be large enough to capture an image of the pen tip 202 at location 212. For reference, the image at location 212 is referred to as the virtual pen tip. It is noted that the virtual pen tip location with respect to image sensor 211 is fixed because of the constant relationship between the pen tip, the lens 208, and the image sensor 211.

The following transformation F_{→P} transforms position coordinates in the image captured by camera to position coordinates in the real image on the paper:
Lₚₐₚₑᵣ=F_{S→P}(L_{Sensor}).

During writing, the pen tip and the paper are on the same plane. Accordingly, the transformation from the virtual pen tip to the real pen tip is also F_{S→P}.
Lₚₑₙₜᵢₚ=F_{S→P}(Lᵥᵢᵣₜᵤₐₗ₋ₚₑₙₜᵢₚ).

The transformation F_{S→P} may be estimated as an affine transform, which approximates F_{S→P} as:

$${F}_{S -> P}^{′} = [ \begin{matrix}\frac{sin {θ}_{y}}{{s}_{x}} & \frac{cos {θ}_{y}}{{s}_{x}} & 0 \\ \frac{- sin {θ}_{x}}{{s}_{y}} & \frac{- cos {θ}_{x}}{{s}_{y}} & 0 \\ 0 & 0 & 1\end{matrix} ] ,$$

in which θₓ, θ_{y}, sₓ, and s_{y} are the rotation and scale of two orientations of the pattern captured at location 204. Further, one can refine F′_{S→P} by matching the captured image with the corresponding real image on paper. “Refine” means to get a more precise estimation of the transformation F_{S→P} by a type of optimization algorithm referred to as a recursive method. The recursive method treats the matrix F′_{S→P} as the initial value. The refined estimation describes the transformation between S and P more precisely.

Next, one can determine the location of virtual pen tip by calibration.

One places the pen tip 202 on a fixed location Lₚₑₙₜᵢₚ on paper. Next, one tilts the pen, allowing the camera 203 to capture a series of images with different pen poses. For each image captured, one may obtain the transformation F_{S→P}. From this transformation, one can obtain the location of the virtual pen tip Lᵥᵢᵣₜᵤₐₗ₋ₚₑₙₜᵢₚ:
Lᵥᵢᵣₜᵤₐₗ₋ₚₑₙₜᵢₚ=F_{P→S}(Lₚₑₙₜᵢₚ),
where Lₚₑₙₜᵢₚ is initialized as (0, 0) and
F_{P→S}=(F_{S→P})⁻¹.

By averaging the Lᵥᵢᵣₜᵤₐₗ₋ₚₑₙₜᵢₚ obtained from each image, a location of the virtual pen tip Lᵥᵢᵣₜᵤₐₗ₋ₚₑₙₜᵢₚ may be determined. With Lᵥᵢᵣₜᵤₐₗ₋ₚₑₙₜᵢₚ) one can get a more accurate estimation of Lₚₑₙₜᵢₚ. After several times of iteration, an accurate location of virtual pen tip Lᵥᵢᵣₜᵤₐₗ₋ₚₑₙₜᵢₚ may be determined.

The location of the virtual pen tip Lᵥᵢₜᵤₐₗ₋ₚₑₙₜᵢₚ is now known. One can also obtain the transformation F_{S→P} from the images captured. Finally, one can use this information to determine the location of the real pen tip Lₚₑₙₜᵢₚ:
Lₚₑₙₜᵢₚ=F_{S→P}(Lᵥᵢᵣₜᵤₐₗ₋ₚₑₙₜᵢₚ).

Encoding of Array

A two-dimensional array may be constructed by folding a one-dimensional sequence. Any portion of the two-dimensional array containing a large enough number of bits may be used to determine its location in the complete two-dimensional array. However, it may be necessary to determine the location from a captured image or a few captured images. So as to minimize the possibility of a captured image portion being associated with two or more locations in the two-dimensional array, a non-repeating sequence may be used to create the array. One property of a created sequence is that the sequence does not repeat over a length (or window) n. The following describes the creation of the one-dimensional sequence then the folding of the sequence into an array.

### Sequence Construction

A sequence of numbers may be used as the starting point of the encoding system. For example, a sequence (also referred to as an m-sequence) may be represented as a q-element set in field F_{q}. Here, q=pⁿ where n≧1 and p is a prime number. The sequence or m-sequence may be generated by a variety of different techniques including, but not limited to, polynomial division. Using polynomial division, the sequence may be defined as follows:

$$\frac{{R}_{l} ( x )}{{P}_{n} ( x )} ,$$

where Pₙ(x) is a primitive polynomial of degree n in field F_{q}[x] (having qⁿ elements). Rₗ(x) is a nonzero polynomial of degree l (where l<n) in field F_{q}[x]. The sequence may be created using an iterative procedure with two steps: first, dividing the two polynomials (resulting in an element of field F_{q}) and, second, multiplying the remainder by x. The computation stops when the output begins to repeat. This process may be implemented using a linear feedback shift register as set forth in an article by Douglas W. Clark and Lih-Jyh Weng, “Maximal and Near-Maximal Shift Register Sequences: Efficient Event Counters and Easy Discrete Logarithms,” IEEE Transactions on Computers 43.5 (May 1994, pp 560-568). In this environment, a relationship is established between cyclical shifting of the sequence and polynomial Rₗ(x): changing Rₗ(x) only cyclically shifts the sequence and every cyclical shifting corresponds to a polynomial Rₗ(x). One of the properties of the resulting sequence is that, the sequence has a period of qⁿ−1 and within a period, over a width (or length) n, any portion exists once and only once in the sequence. This is called the “window property”. Period qⁿ−1 is also referred to as the length of the sequence and n as the order of the sequence.

The process described above is but one of a variety of processes that may be used to create a sequence with the window property.

### Array Construction

The array (or m-array) that may be used to create the image (of which a portion may be captured by the camera) is an extension of the one-dimensional sequence or m-sequence. Let A be an array of period (m₁, m₂), namely A(k+m₁,l)=A(k,l+m₂)=A(k,l). When an n₁×n₂ window shifts through a period of A, all the nonzero n₁×n₂ matrices over F_{q} appear once and only once. This property is also referred to as a “window property” in that each window is unique. A widow may then be expressed as an array of period (m₁, m₂) (with m₁ and m₂ being the horizontal and vertical number of bits present in the array) and order (n₁, n₂).

A binary array (or m-array) may be constructed by folding the sequence. One approach is to obtain a sequence then fold it to a size of m₁×m₂ where the length of the array is L=m₁×m₂=2ⁿ−1. Alternatively, one may start with a predetermined size of the space that one wants to cover (for example, one sheet of paper, 30 sheets of paper or the size of a computer monitor), determine the area (m₁×m₂), then use the size to let L≧m₁−m₂, where L=2ⁿ−1.

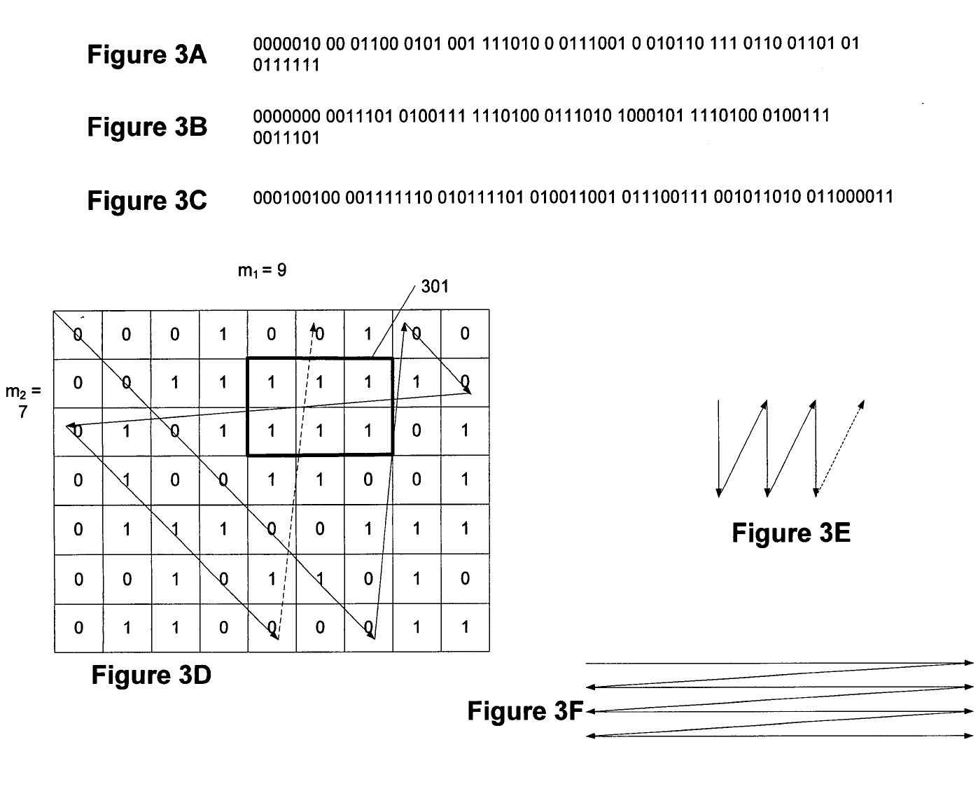

A variety of different folding techniques may be used. For example, FIGS. 3A through 3C show three different sequences. Each of these may be folded into the array shown as FIG. 3D. The three different folding methods are shown as the overlay in FIG. 3D and as the raster paths in FIGS. 3E and 3F. We adopt the folding method shown in FIG. 3D.

To create the folding method as shown in FIG. 3D, one creates a sequence {aᵢ} of length L and order n. Next, an array {bₖₗ} of size m₁×m₂, where gcd(m₁, m₂)=1 and L=m₁×m₂, is created from the sequence {aᵢ} by letting each bit of the array be calculated as shown by equation 1:
bₖₗ=aᵢ, where k=i mod(m₁), l=i mod(m₂), i=0, . . . , L−1. (1)

This folding approach may be alternatively expressed as laying the sequence on the diagonal of the array, then continuing from the opposite edge when an edge is reached.

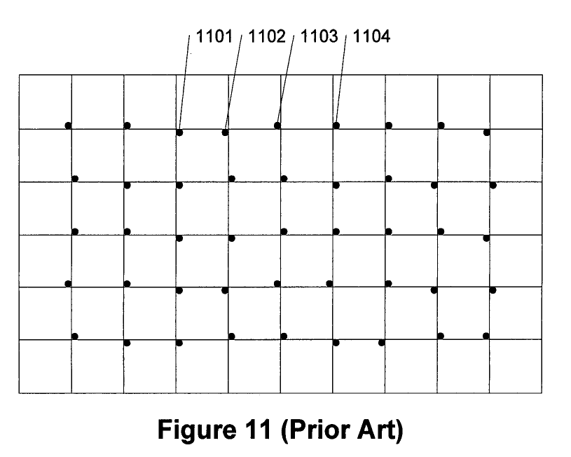

FIG. 4A shows sample encoding techniques that may be used to encode the array of FIG. 3D. It is appreciated that other encoding techniques may be used. For example, an alternative coding technique is shown in FIG. 11.

Referring to FIG. 4A, a first bit 401 (for example, “1”) is represented by a column of dark ink. A second bit 402 (for example, “0”) is represented by a row of dark ink. It is appreciated that any color ink may be used to represent the various bits. The only requirement in the color of the ink chosen is that it provides a significant contrast with the background of the medium to be differentiable by an image capture system. The bits in FIG. 4A are represented by a 3×3 matrix of cells. The size of the matrix may be modified to be any size as based on the size and resolution of an image capture system. Alternative representation of bits 0 and 1 are shown in FIGS. 4C-4E. It is appreciated that the representation of a one or a zero for the sample encodings of FIGS. 4A-4E may be switched without effect. FIG. 4C shows bit representations occupying two rows or columns in an interleaved arrangement. FIG. 4D shows an alternative arrangement of the pixels in rows and columns in a dashed form. Finally FIG. 4E shows pixel representations in columns and rows in an irregular spacing format (e.g., two dark dots followed by a blank dot).

Referring back to FIG. 4A, if a bit is represented by a 3×3 matrix and an imaging system detects a dark row and two white rows in the 3×3 region, then a zero is detected (or one). If an image is detected with a dark column and two white columns, then a one is detected (or a zero).

Here, more than one pixel or dot is used to represent a bit. Using a single pixel (or bit) to represent a bit is fragile. Dust, creases in paper, non-planar surfaces, and the like create difficulties in reading single bit representations of data units. However, it is appreciated that different approaches may be used to graphically represent the array on a surface. Some approaches are shown in FIGS. 4C through 4E. It is appreciated that other approaches may be used as well. One approach is set forth in FIG. 11 using only space-shifted dots.

A bit stream is used to create the graphical pattern 403 of FIG. 4B. Graphical pattern 403 includes 12 rows and 18 columns. The rows and columns are formed by a bit stream that is converted into a graphical representation using bit representations 401 and 402. FIG. 4B may be viewed as having the following bit representation:

$$[ \begin{matrix}0 & 1 & 0 & 1 & 0 & 1 & 1 & 1 & 0 \\ 1 & 1 & 0 & 1 & 1 & 0 & 0 & 1 & 0 \\ 0 & 0 & 1 & 0 & 1 & 0 & 0 & 1 & 1 \\ 1 & 0 & 1 & 1 & 0 & 1 & 1 & 0 & 0\end{matrix} ] .$$

Decoding

When a person writes with the pen of FIG. 2A or moves the pen close to the encoded pattern, the camera captures an image. For example, pen 201 may utilize a pressure sensor as pen 201 is pressed against paper and pen 201 traverses a document on the paper. The image is then processed to determine the orientation of the captured image with respect to the complete representation of the encoded image and extract the bits that make up the captured image.

For the determination of the orientation of the captured image relative to the whole encoded area, one may notice that not all the four conceivable corners shown in FIG. 5A-5D can present in the graphical pattern 403. In fact, with the correct orientation, the type of corner shown in FIG. 5A cannot exist in the graphical pattern 403. Therefore, the orientation in which the type of corner shown in FIG. 5A is missing is the right orientation.

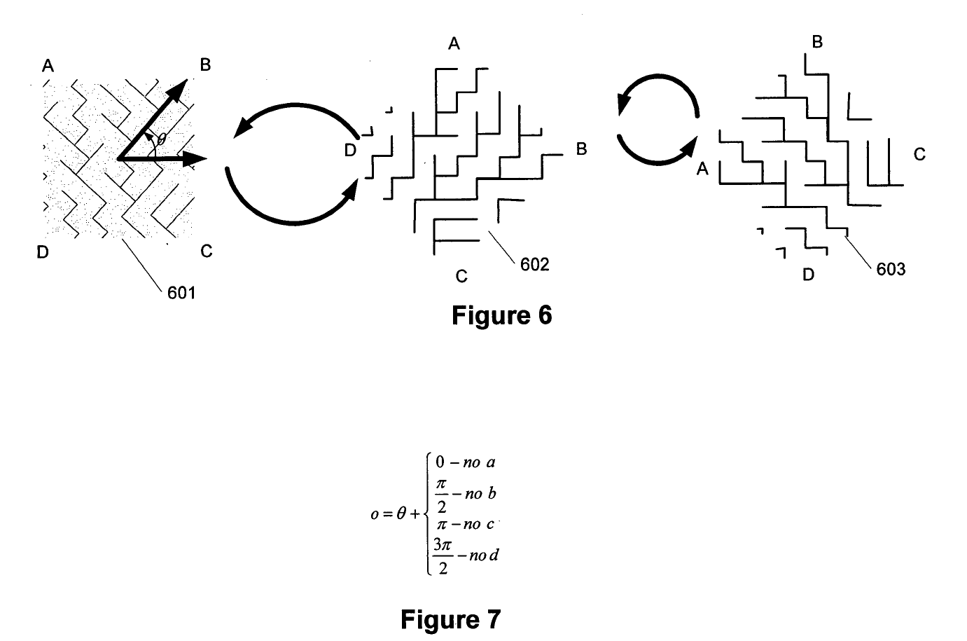

Continuing to FIG. 6, the image captured by a camera 601 may be analyzed and its orientation determined so as to be interpretable as to the position actually represented by the image 601. First, image 601 is reviewed to determine the angle θ needed to rotate the image so that the pixels are horizontally and vertically aligned. It is noted that alternative grid alignments are possible including a rotation of the underlying grid to a non-horizontal and vertical arrangement (for example, 45 degrees). Using a non-horizontal and vertical arrangement may provide the probable benefit of eliminating visual distractions from the user, as users may tend to notice horizontal and vertical patterns before others. For purposes of simplicity, the orientation of the grid (horizontal and vertical and any other rotation of the underlying grid) is referred to collectively as the predefined grid orientation.

Next, image 601 is analyzed to determine which corner is missing. The rotation amount o needed to rotate image 601 to an image ready for decoding 603 is shown as o=(θ plus a rotation amount {defined by which corner missing}). The rotation amount is shown by the equation in FIG. 7. Referring back to FIG. 6, angle θ is first determined by the layout of the pixels to arrive at a horizontal and vertical (or other predefined grid orientation) arrangement of the pixels and the image is rotated as shown in 602. An analysis is then conducted to determine the missing corner and the image 602 rotated to the image 603 to set up the image for decoding. Here, the image is rotated 90 degrees counterclockwise so that image 603 has the correct orientation and can be used for decoding.

is appreciated that the rotation angle θ may be applied before or after rotation of the image 601 to account for the missing corner. It is also appreciated that by considering noise in the captured image, all four types of corners may be present. We may count the number of corners of each type and choose the type that has the least number as the corner type that is missing.

Finally, the code in image 603 is read out and correlated with the original bit stream used to create image 403. The correlation may be performed in a number of ways. For example, it may be performed by a recursive approach in which a recovered bit stream is compared against all other bit stream fragments within the original bit stream. Second, a statistical analysis may be performed between the recovered bit stream and the original bit stream, for example, by using a Hamming distance between the two bit streams. It is appreciated that a variety of approaches may be used to determine the location of the recovered bit stream within the original bit stream.

As will be discussed, maze pattern analysis obtains recovered bits from image 603. Once one has the recovered bits, one needs to locate the captured image within the original array (for example, the one shown in FIG. 4B). The process of determining the location of a segment of bits within the entire array is complicated by a number of items. First, the actual bits to be captured may be obscured (for example, the camera may capture an image with handwriting that obscures the original code). Second, dust, creases, reflections, and the like may also create errors in the captured image. These errors make the localization process more difficult. In this regard, the image capture system may need to function with non-sequential bits extracted from the image. The following represents a method for operating with non-sequential bits from the image.

Let the sequence (or m-sequence) I correspond to the power series I(x)=1/Pₙ(x), where n is the order of the m-sequence, and the captured image contains K bits b=(b₀ b₁ b₂ . . . b_{K-1})^{t} of I, where K≧n and the superscript t represents a transpose of the matrix or vector. The location s of the K bits is just the number of cyclic shifts of I so that b₀ is shifted to the beginning of the sequence. Then this shifted sequence R corresponds to the power series x^{s}/Pₙ(x), or R=T^{s}(I), where T is the cyclic shift operator. We find this s indirectly. The polynomials modulo Pₙ(x) form a field. It is guaranteed that x^{s}≡r₀+r₁x+ . . . rₙ₋₁xⁿ⁻¹ mod(Pₙ(x)). Therefore, we may find (r₀, r₁, . . . , rₙ₋₁) and then solve for s.

The relationship x^{s}≡r₀+r₁x+ . . . rₙ₋₁xⁿ⁻¹ mod (Pₙ(x)) implies that R=r₀+r₁T(I)+ . . . +rₙ₋₁Tⁿ⁻¹(I). Written in a binary linear equation, it becomes:
R=r^{t}A, (2)
where r=(r₀ r₁ r₂ . . . rₙ₋₁)^{t}, and A=(I T(I) . . . Tⁿ⁻¹(I)^{t} which consists of the cyclic shifts of I from 0-shift to (n-1)-shift. Now only sparse K bits are available in R to solve r. Let the index differences between b₁ and b₀ in R be kᵢ, i=1,2, . . . , k−1, then the 1^{st} and (kᵢ+1)-th elements of R, i=1,2, . . . , k−1, are exactly b₀, b₁, . . . , bₖ₋₁. By selecting the 1^{st} and ( kᵢ+1)-th columns of A, i=1,2, . . . , k−1, the following binary linear equation is formed:
b^{t}=r^{t}M, (3)
where M is an n x K sub-matrix of A.

If b is error-free, the solution of r may be expressed as:
r^{t}=\tilde{b}^{t}\tilde{M}⁻¹, (4)
where \tilde{M} is any non-degenerate n×n sub-matrix of M and \tilde{b} is the corresponding sub-vector of b.

With known r, we may use the Pohlig-Hellman-Silver algorithm as noted by Douglas W. Clark and Lih-Jyh Weng, “Maximal and Near-Maximal Shift Register Sequences: Efficient Event Counters and Easy Discrete Logorithms,” IEEE Transactions on Computers 43.5 (May 1994, pp 560-568) to find s so that x^{s}≡r₀+r₁x+ . . . rₙ₋₁xⁿ⁻¹mod(Pₙ(x)).

As matrix A (with the size of n by L, where L=2ⁿ−1) may be huge, we should avoid storing the entire matrix A. In fact, as we have seen in the above process, given extracted bits with index difference kᵢ, only the first and (kᵢ+1)-th columns of A are relevant to the computation. Such choices of kᵢ is quite limited, given the size of the captured image. Thus, only those columns that may be involved in computation need to saved. The total number of such columns is much smaller than L (where L=2ⁿ−1 is the length of the m-sequence).

Error Correction

If errors exist in b, then the solution of r becomes more complex. Traditional methods of decoding with error correction may not readily apply, because the matrix M associated with the captured bits may change from one captured image to another.

We adopt a stochastic approach. Assuming that the number of error bits in b, nₑ, is relatively small compared to K, then the probability of choosing correct n bits from the K bits of b and the corresponding sub-matrix \tilde{M} of M being non-degenerate is high.

When the n bits chosen are all correct, the Hamming distance between b^{t} and r^{t}M, or the number of error bits associated with r, should be minimal, where r is computed via equation (4). Repeating the process for several times, it is likely that the correct r that results in the minimal error bits can be identified.

If there is only one r that is associated with the minimum number of error bits, then it is regarded as the correct solution. Otherwise, if there is more than one r that is associated with the minimum number of error bits, the probability that nₑ exceeds the error correcting ability of the code generated by M is high and the decoding process fails. The system then may move on to process the next captured image. In another implementation, information about previous locations of the pen can be taken into consideration. That is, for each captured image, a destination area where the pen may be expected next can be identified. For example, if the user has not lifted the pen between two image captures by the camera, the location of the pen as determined by the second image capture should not be too far away from the first location. Each r that is associated with the minimum number of error bits can then be checked to see if the location s computed from r satisfies the local constraint, i.e., whether the location is within the destination area specified.

If the location s satisfies the local constraint, the X, Y positions of the extracted bits in the array are returned. If not, the decoding process fails.

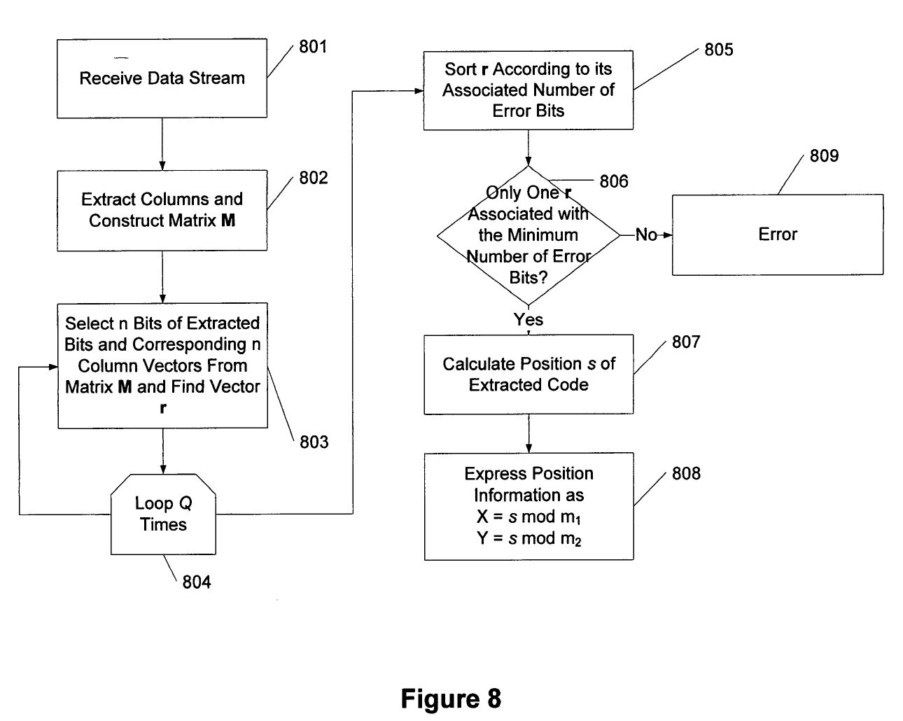

FIG. 8 depicts a process that may be used to determine a location in a sequence (or m-sequence) of a captured image. First, in step 801, a data stream relating to a captured image is received. In step 802, corresponding columns are extracted from A and a matrix M is constructed.

In step 803, n independent column vectors are randomly selected from the matrix M and vector r is determined by solving equation (4). This process is performed Q times (for example, 100 times) in step 804. The determination of the number of loop times is discussed in the section Loop Times Calculation.

In step 805, r is sorted according to its associated number of error bits. The sorting can be done using a variety of sorting algorithms as known in the art. For example, a selection sorting algorithm may be used. The selection sorting algorithm is beneficial when the number Q is not large. However, if Q becomes large, other sorting algorithms (for example, a merge sort) that handle larger numbers of items more efficiently may be used.

The system then determines in step 806 whether error correction was performed successfully, by checking whether multiple r's are associated with the minimum number of error bits. If yes, an error is returned in step 809, indicating the decoding process failed. If not, the position s of the extracted bits in the sequence (or m-sequence) is calculated in step 807, for example, by using the Pohig-Hellman-Silver algorithm.

Next, the (X,Y) position in the array is calculated as: x=s mod m₁ and y=s mod m₂ and the results are returned in step 808.

Location Determination

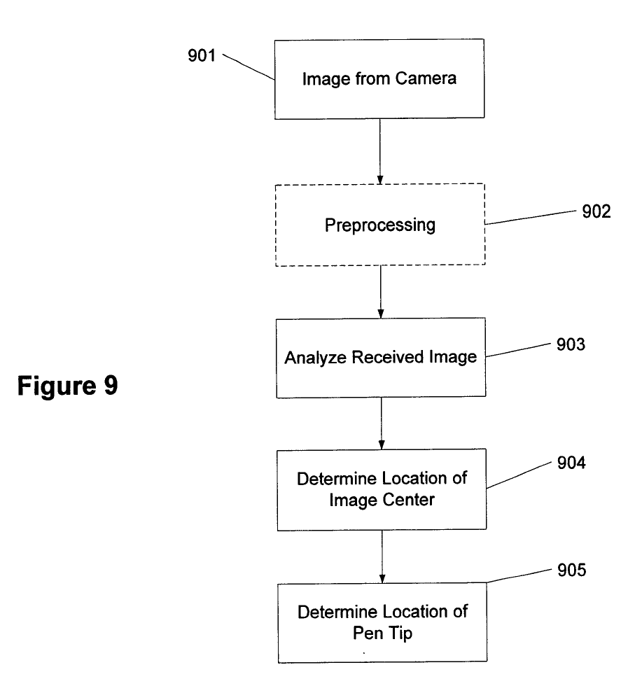

FIG. 9 shows a process for determining the location of a pen tip. The input is an image captured by a camera and the output may be a position coordinates of the pen tip. Also, the output may include (or not) other information such as a rotation angle of the captured image.

In step 901, an image is received from a camera. Next, the received image may be optionally preprocessed in step 902 (as shown by the broken outline of step 902) to adjust the contrast between the light and dark pixels and the like.

Next, in step 903, the image is analyzed to determine the bit stream within it.

Next, in step 904, n bits are randomly selected from the bit stream for multiple times and the location of the received bit stream within the original sequence (or m-sequence) is determined.

Finally, once the location of the captured image is determined in step 904, the location of the pen tip may be determined in step 905.

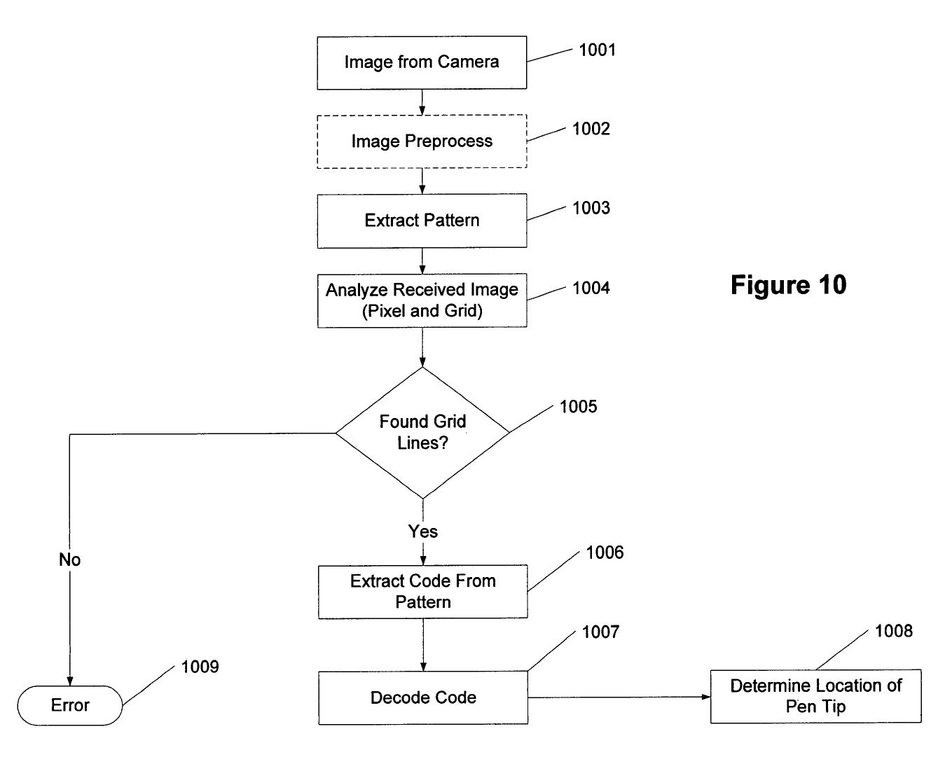

FIG. 10 gives more details about 903 and 904 and shows the approach to extract the bit stream within a captured image. First, an image is received from the camera in step 1001. The image then may optionally undergo image preprocessing in step 1002 (as shown by the broken outline of step 1002). The pattern is extracted in step 1003. Here, pixels on the various lines may be extracted to find the orientation of the pattern and the angle θ.

Next, the received image is analyzed in step 1004 to determine the underlying grid lines. If grid lines are found in step 1005, then the code is extracted from the pattern in step 1006. The code is then decoded in step 1007 and the location of the pen tip is determined in step 1008. If no grid lines were found in step 1005, then an error is returned in step 1009.

Outline of Enhanced Decoding and Error Correction Algorithm

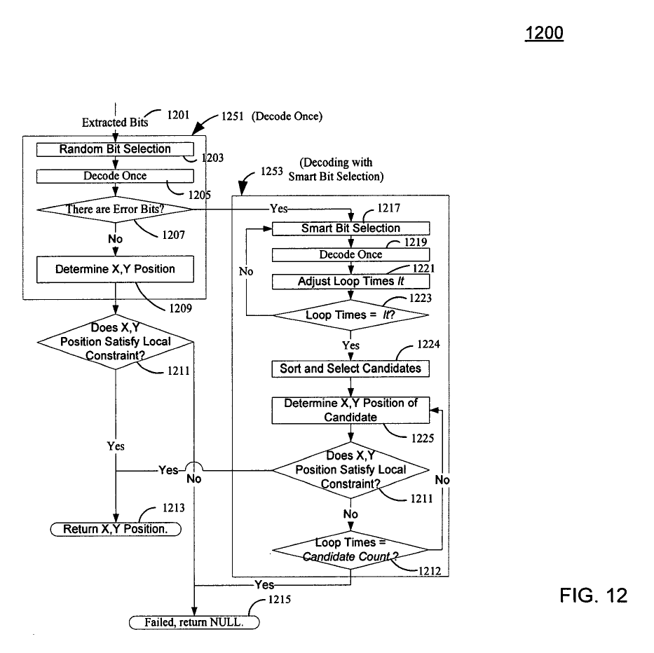

With an embodiment of the invention as shown in FIG. 12, given extracted bits 1201 from a captured image (corresponding to a captured array) and the destination area, a variation of an m-array decoding and error correction process decodes the X,Y position. FIG. 12 shows a flow diagram of process 1200 of this enhanced approach. Process 1200 comprises two components 1251 and 1253.

Decode Once. Component 1251 include three parts.
random bit selection: randomly selects a subset of the extracted bits 1201 (step 1203)
decode the subset (step 1205)
determine X,Y position with local constraint (step 1209)

Decoding with Smart Bit Selection. Component 1253 include four parts.
smart bit selection: selects another subset of the extracted bits (step 1217)
decode the subset (step 1219)
adjust the number of iterations (loop times) of step 1217 and step 1219 (step 1221)
determine X,Y position with local constraint (step 1225)

The embodiment of the invention utilizes a discreet strategy to select bits, adjusts the number of loop iterations, and determines the X,Y position (location coordinates) in accordance with a local constraint, which is provided to process 1200. With both components 1251 and 1253, steps 1205 and 1219 (“Decode Once”) utilize equation (4) to compute r.

Let b be decoded bits, that is:
\hat{b}′=r^{t}M (5)
The difference between b and \hat{b} are the error bits associated with r.

FIG. 12 shows a flow diagram of process 1200 for decoding extracted bits 1201 from a captured image in accordance with embodiments of the present invention. Process 1200 comprises components 1251 and 1253. Component 1251 obtains extracted bits 1201 (comprising K bits) associated with a captured image (corresponding to a captured array). In step 1203, n bits (where n is the order of the m-array) are randomly selected from extracted bits 1201. In step 1205, process 1200 decodes once and calculates r. In step 1207, process 1200 determines if error bits are detected for b. If step 1207 determines that there are no error bits, X,Y coordinates of the position of the captured array are determined in step 1209. With step 1211, if the X,Y coordinates satisfy the local constraint, i.e., coordinates that are within the destination area, process 1200 provides the X,Y position (such as to another process or user interface) in step 1213. Otherwise, step 1215 provides a failure indication.

If step 1207 detects error bits in b, component 1253 is executed in order to decode with error bits. Step 1217 selects another set of n bits (which differ by at least one bit from the n bits selected in step 1203) from extracted bits 1201. Steps 1221 and 1223 determine the number of iterations (loop times) that are necessary for decoding the extracted bits. Step 1225 determines the position of the captured array by testing which candidates obtained in step 1219 satisfy the local constraint. Steps 1217-1225 will be discussed in more details.

Smart Bit Selection

Step 1203 randomly selects n bits from extracted bits 1201 (having K bits), and solves for r₁. Using equation (5), decoded bits can be calculated. Let I₁={k ε{1,2, . . . , K}|bₖ=\hat{b}ₖ}, \overline{I}₁={k ε{1,2, . . . , K}|b_{b}≠\hat{b}ₖ}, where \hat{b}ₖ is the k^{th} bit of \hat{b}, B₁={bₖ|k εI₁} and \overline{B}₁{bₖ|k ε\overline{I}₁}, that is, B₁ are bits that the decoded results are the same as the original bits, and \overline{B}₁ are bits that the decoded results are different from the original bits, I₁ and \overline{I}₁ are the corresponding indices of these bits. It is appreciated that the same r₁ will be obtained when any n independent bits are selected from B₁. Therefore, if the next n bits are not carefully chosen, it is possible that the selected bits are a subset of B₁, thus resulting in the same r₁ being obtained.

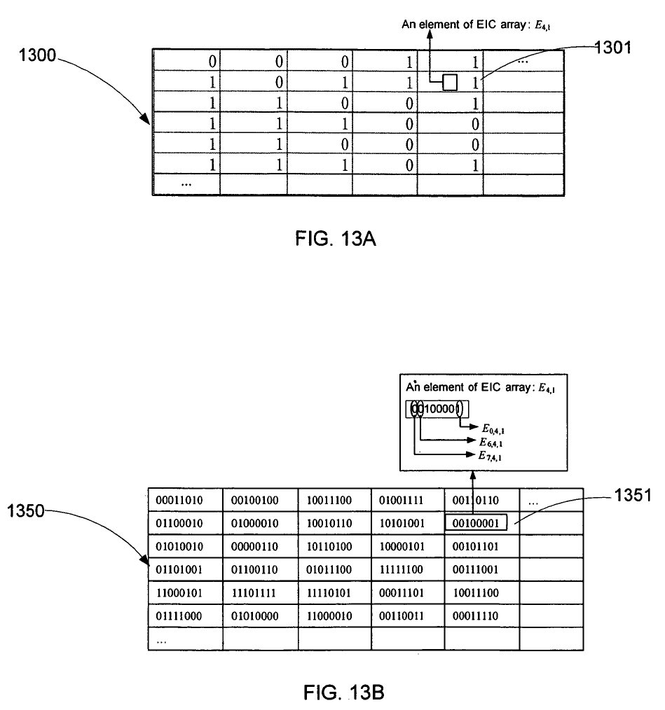

In order to avoid such a situation, step 1217 selects the next n bits according to the following procedure:
1. Choose at least one bit from \overline{B}₁ 1303 and the rest of the bits randomly from B₁ 1301 and \overline{B}₁ 1303, as shown in FIG. 13 corresponding to bit arrangement 1351. Process 1200 then solves r₂ and finds B₂ 1305, 1309 and \overline{B}₂ 1307, 1311 by computing \hat{b}₂=r₂^{t}M₂.
2. Repeat step 1. When selecting the next n bits, for every \overline{B}ᵢ (i=1, 2, 3 . . . , x-1, where x is the current loop number), there is at least one bit selected from \overline{B}ᵢ. The iteration terminates when no such subset of bits can be selected or when the loop times are reached.

Loop Times Calculation

With the error correction component 1253, the number of required iterations (loop times) is adjusted after each loop. The loop times is determined by the expected error rate. The expected error rate pₑ in which not all the selected n bits are correct is:

$${p}_{e} = {( 1 - \frac{{C}_{K - {n}_{e}}^{n}}{{C}_{K}^{n}} )}^{lt} \approx - {ⅇ}^{- {lt ( \frac{K - n}{K} )}^{{n}_{e}}} , \qquad ( 6 )$$

where lt represents the loop times and is initialized by a constant, K is the number of extracted bits from the captured array, nₑ represents the minimum number of error bits incurred during the iteration of process 1200, n is the order of the m-array, and C_{K}ⁿ is the number of combinations in which n bits are selected from K bits.

In the embodiment, we want pₑ to be less than e⁻⁵=0.0067. In combination with (6), we have:

$${lt}_{i} = min ( {lt}_{i - 1} , \frac{5}{{( \frac{K - n}{K} )}^{{n}_{e}}} + 1 ) . \qquad ( 7 )$$

Adjusting the loop times may significantly reduce the number of iterations of process 1253 that are required for error correction.

Determine X, Y Position with Local Constraint

In steps 1209 and 1225, the decoded position should be within the destination area. The destination area is an input to the algorithm, and it may be of various sizes and places or simply the whole m-array depending on different applications. Usually it can be predicted by the application. For example, if the previous position is determined, considering the writing speed, the destination area of the current pen tip should be close to the previous position. However, if the pen is lifted, then its next position can be anywhere. Therefore, in this case, the destination area should be the whole m-array. The correct X,Y position is determined by the following steps.

In step 1224 process 1200 selects rᵢ whose corresponding number of error bits is less than:

$${N}_{e} = \frac{{log}_{10} ( \frac{3}{lt} )}{{log}_{10} ( \frac{K - n}{K} ) \times {log}_{10} ( \frac{10}{lr} )} , \qquad ( 8 )$$

where lt is the actual loop times and lr represents the Local Constraint Rate calculated by:

$$lr = \frac{area of the destination area}{L} , \qquad ( 9 )$$

where L is the length of the m-array.

Step 1224 sorts rᵢ in ascending order of the number of error bits. Steps 1225, 1211 and 1212 then finds the first rᵢ in which the corresponding X,Y position is within the destination area. Steps 1225, 1211 and 1212 finally returns the X,Y position as the result (through step 1213), or an indication that the decoding procedure failed (through step 1215).

Illustrative Example of Enhanced Decoding and Error Correction Process

An illustrative example demonstrates process 1200 as performed by components 1251 and 1253. Suppose n=3, K=5, I=(I₀ I₁ . . . I₆)^{t} is the m-sequence of order n=3. Then

$$A = ( \begin{matrix}{I}_{0} & {I}_{1} & {I}_{2} & {I}_{3} & {I}_{4} & {I}_{5} & {I}_{6} \\ {I}_{6} & {I}_{0} & {I}_{1} & {I}_{2} & {I}_{3} & {I}_{4} & {I}_{5} \\ {I}_{5} & {I}_{6} & {I}_{0} & {I}_{1} & {I}_{2} & {I}_{3} & {I}_{4}\end{matrix} ) , \qquad ( 10 )$$

Also suppose that the extracted bits b=(b₀ b₁ b₂ b₃ b₄)^{t}, where K=5, are actually the s^{th}, (s+1)^{th}, (s+3)^{th}, (s+4)^{th}, and (s+6)^{th} bits of the m-sequence (these numbers are actually modulus of the m-array length L=2ⁿ−1=2³−1=7). Therefore

$$M = ( \begin{matrix}{I}_{0} & {I}_{1} & {I}_{3} & {I}_{4} & {I}_{6} \\ {I}_{6} & {I}_{0} & {I}_{2} & {I}_{3} & {I}_{5} \\ {I}_{5} & {I}_{6} & {I}_{1} & {I}_{2} & {I}_{4}\end{matrix} ) , \qquad ( 11 )$$

which consists of the 0^{th}, 1^{st}, 3^{rd}, 4^{th}, and 6^{th} columns of A. The number s, which uniquely determines the X,Y position of b₀ in the m-array, can be computed after solving r=(r₀ r₁ r₂)^{t} that are expected to fulfill b^{t}=r^{t}M. Due to possible error bits in b, b^{t}=r^{t}M may not be completely fulfilled.

Process 1200 utilizes the following procedure. Randomly select n=3 bits, say \tilde{b}₁^{t}=(b₀ b₁ b₂), from b. Solving for r₁:
\tilde{b}₁^{t}=r₁^{t}\tilde{M}₁, (12)
where M₁ consists of the 0th, 1st, and 2nd columns of M. (Note that \tilde{M}₁ is an n×n matrix and r₁^{t} is a 1×n vector so that \tilde{b}₁^{t} is a 1×n vector of selected bits.)

Next, decoded bits are computed:
\hat{b}₁^{t}=r₁^{t}M, (13)
where M is an n×K matrix and r₁^{t} is a 1×n vector so that \hat{b}₁^{t} is a 1×K vector. If \hat{b}₁ is identical to b, i.e., no error bits are detected, then step 1209 determines the X,Y position and step 1211 determines whether the decoded position is inside the destination area. If so, the decoding is successful, and step 1213 is performed. Otherwise, the decoding fails as indicated by step 1215. If \hat{b}₁ is different from b, then error bits in b are detected and component 1253 is performed. Step 1217 determines the set B₁, say {b₀ b₁ b₂ b₃}, where the decoded bits are the same as the original bits. Thus, \overline{B}₁={b₄} (corresponding to bit arrangement 1351 in FIG. 13). Loop times (lt) is initialized to a constant, e.g., 100, which may be variable depending on the application. Note that the number of error bits corresponding to r₁ is equal to 1. Then step 1221 updates the loop time (lt) according to equation (7), lt₁=min(lt, 13)=13.

Step 1217 next chooses another n=3 bits from b. If the bits all belong to B₁, say {b₀ b₂ b₃}, then step 1219 will determine r₁ again. In order to avoid such repetition, step 1217 may select, for example, one bit {b₄} from \overline{B}₁, and the remaining two bits {b₀ b₁} from By.

The selected three bits form \tilde{b}₂^{t}=(b₀ b₁ b₄). Step 1219 solves for r₂:
\tilde{b}₂^{t}=r₂^{t}\tilde{M}₂, (14)
where \tilde{M}₂ consists of the 0^{th}, 1^{st}, and 4^{th} columns of M.

Step 1219 computes \hat{b}₂^{t}M=r₂^{t}M. Find the set B₂, e.g., {b₀ b₁ b₄}such that \hat{b}₂ and b are the same. Then \overline{B}₂={b₂ b₃} (corresponding to bit arrangement 1353 in FIG. 13). Step 1221 updates the loop times (lt) according to equation (7). Note that the number of error bits associated with r₂ is equal to 2. Substituting into (7), lt₂=min(lt₁, 32)=13.

Because another iteration needs to be performed, step 1217 chooses another n=3 bits from b. The selected bits shall not all belong to either B₁ or B₂. So step 1217 may select, for example, one bit {b₄} from \overline{B}₁, one bit {b₂} from \overline{B}₂, and the remaining one bit {b₀}.

The solution of r, bit selection, and loop times adjustment continues until we cannot select any new n=3 bits such that they do not all belong to any previous Bᵢ's, or the maximum loop times It is reached.

Suppose that process 1200 calculates five rᵢ (i=1,2,3,4,5), with the number of error bits corresponding to 1, 2, 4, 3, 2, respectively. (Actually, for this example, the number of error bits cannot exceed 2, but the illustrative example shows a larger number of error bits to illustrate the algorithm.) Step 1224 selects rᵢ's, for example, r₁,r₂,r₄,r₅, whose corresponding numbers of error bits are less than Nₑ shown in (8).

Step 1224 sorts the selected vectors r₁,r₂,r₄,r₅ in ascending order of their error bit numbers: r₁,r₂,r₅,r₄. From the sorted candidate list, steps 1225, 1211 and 1212 find the first vector r, for example, r₅, whose corresponding position is within the destination area. Step 1213 then outputs the corresponding position. If none of the positions is within the destination area, the decoding process fails as indicated by step 1215.

Embedding Method for Embedded Interaction Code Array

In order to determine the position of a digital pen on a document, information encoded in an embedded interaction code (EIC) is extracted from the document. The present invention defines and selects an optimal set of EIC fonts for visually representing the EIC symbols on different surfaces including printed documents. An EIC font refers to a specific size and visual design of an EIC symbol given the number of encoded bits. From a huge set of possible EIC fonts, only a small subset are suitable for practical use based on design considerations, including the efficiency to analyze a captured EIC pattern and segment the EIC symbols from the captured EIC pattern and the robustness of the EIC pattern over various scales, rotations and perspective distortions resulting from pen rotation and tilting.

X-y position information may be embedded in documents on flat surfaces. When an image capturing device moves on such surfaces, the device may track the position by reading the embedded data. The device may be a digital pen with a camera assembled near the pen tip. The surfaces may be blank paper, printed documents, whiteboard or LCD displays. For printed documents, embedding may be done by printing additional black dots (associated with EIC data) together with the document content, i.e. representing x-y position by using the special arrangement of additional black dots. Other technologies may be used to embed data in other surfaces.

When referring to “black dots,” a dot is marked. For example, ink may be applied on a region that is defined by a dot. With a document displayed on a video display device, a pixel or a group of pixels may be illuminated.

Metadata, such as document ID and other global or local information, may be embedded together with the x-y position to distinguish different surfaces or different functional areas in one surface. For example, one may print several documents, and embed a different document ID on the documents. If a digital pen is used to sketch or annotate on these documents, the pen knows both its position and the document ID which is associated with the document. Furthermore, the pen may switch among these documents freely to determine the position of the pen on the associated document.

FIG. 13A shows a one-dimensional embedded interaction code (EIC) according to an embodiment of the present invention. FIG. 13B shows an eight-dimensional EIC according to an embodiment of the present invention. An EIC array may be single EIC array 1300 or multiple binary arrays 1350 for representing x-y position and metadata. Element 1301 encodes one bit, while element 1351 encodes eight bits. A binary array may be an m-array as previously discussed. A binary array of the EIC array corresponds to one dimension of the EIC array. An element E_{x,y} of an EIC array E with K dimensions is represented as a binary sequence b_{K-1,x,y}b_{K-2,x,y} . . . b_{0,x,y}, where b_{i,x,y} is the binary digit (bit) at position (x,y) of the (i+1)th dimension binary array. i is 0, 1, . . . , or K−1. EIC array 1300 and EIC array 1350 have one dimension and eight dimensions, respectively. To obtain the whole address space of an EIC array in an efficient way, the EIC array may have more than one dimension, e.g., four or eight dimensions.

An EIC symbol is the smallest unit for the visual representation of EIC array. An EIC symbol includes:
The data represented. One or more bits may be encoded in one EIC symbol. For an EIC symbol with 1 bit encoded, the represented data may be “0” or “1”. For EIC symbol with 2 bits encoded, the represented data may be “00”, “01”, “10” or “11”.
Physical size. The size of an EIC symbol can be measured by printed dots. For example, EIC symbol may be 16×16 printed dots. With a 600 dpi printer, the diameter of a printed dot is about 0.04233 mm.
Visual representation. For example, if 2 bits are encoded, visual representation refers to the number and position distribution of black dots for representing “00”, “01”, “10” or “11”.

An EIC symbol may be classified by the number of encode bits, e.g., 1 bit EIC symbol, 2 bit EIC symbol, etc.

An EIC font refers to a specific size and visual design of an EIC symbol, given the number of encoded bits. One may select one of different EIC fonts for an EIC symbol with a specified number of bits. An EIC symbol is generated from the selected EIC font.

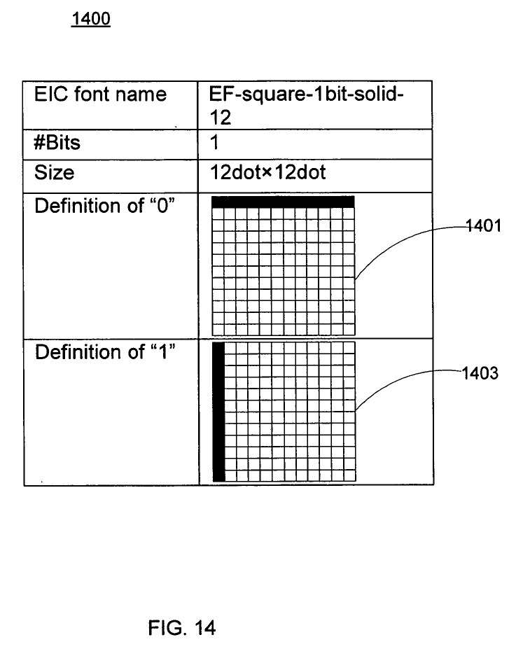

FIG. 14 shows EIC font 1400 that encodes one data (information) bit according to an embodiment of the present invention. Font configurations 1401 and 1403 specify a 1 bit EIC font that is denoted “EF-square-1 bit-solid-12”. EIC font 1400 uses the black dots in the first top row to represent “0” or the black dots in the first left column to represent “1”. Either the top row or the left column, but not both, is marked in an EIC symbol.

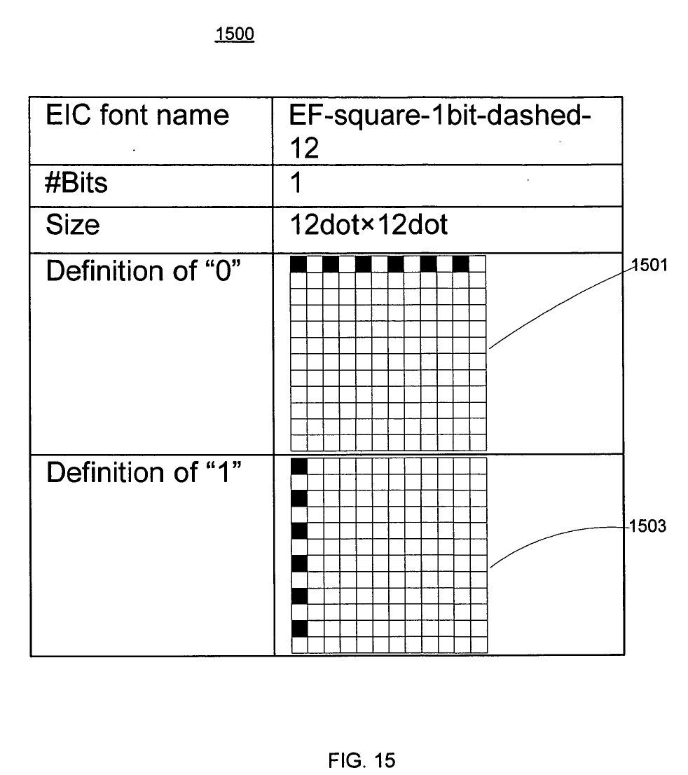

FIG. 15 shows EIC font 1500 that encodes one information bit according to an embodiment of the present invention. EIC font 1500 is denoted as “EF-square-1 bit-dashed-12” which uses the dashed dots to represent “0” (corresponding to EIC configuration 1501) and “1” (corresponding to EIC configuration 1503).

To represent an EIC array with K dimensions, a K×n bit EIC font may be used, where n is an integer, for example, 1, 2, or 3. Consequently n elements of an EIC array are represented in one EIC symbol.

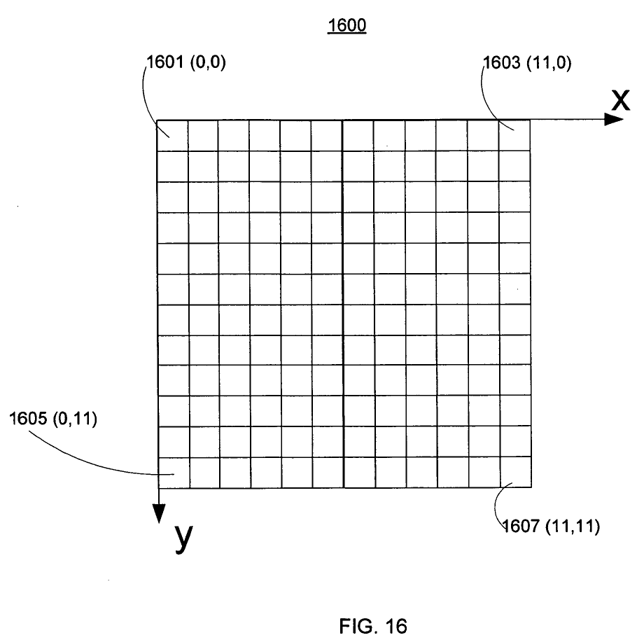

FIG. 16 shows coordinate system 1600 of an EIC symbol according to an embodiment of the present invention. Different EIC fonts may be adapted to different applications, hardware implementations, and document surfaces. With coordinate system 1600, one small square region represents the position of one dot, where the position is represented as (x, y). FIG. 16 shows dots 1601-1607 corresponding to coordinates (0,0), (11,0), (0,11), and (11,11), respectively. As will be discussed, a “dot” can represent EIC data, symbol segmentation (clock dots), and parity check sums.

EIC fonts may be identified by the EIC font (EF) notation:
EF-shape description-# of data bits-dot description-size of font
   Examples of the “shape description” include “square”, “diamond”, and “triangle”. Examples of the “dot description” include “solid”, “dashed”, “dashed-b”, and “dot 05”. The “dot description” may utilize a number of descriptive approach including plain language (e.g., “solid”) or may utilize the coordinate system, e.g., coordinate system 1600. The “size of font” indicates the size of the EIC font and may utilize a coordinate system, e.g., coordinate system 1600. Examples of the “size of font” include “12” (corresponding to a 12 dot by 12 dot region) and “14−12” (corresponding to a 14 dot by 12 dot region.

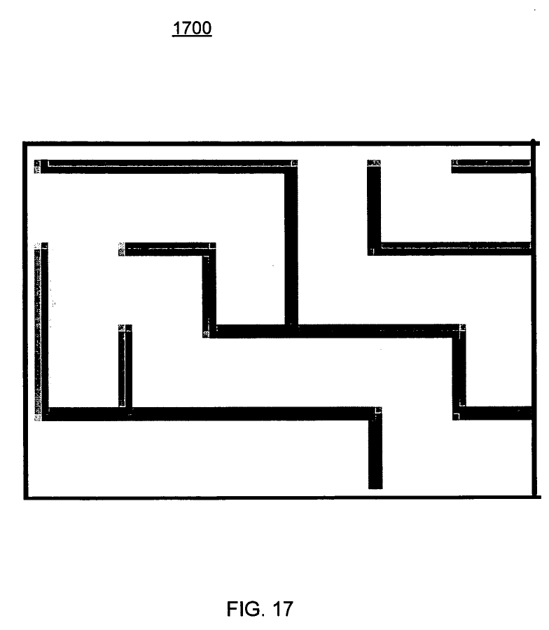

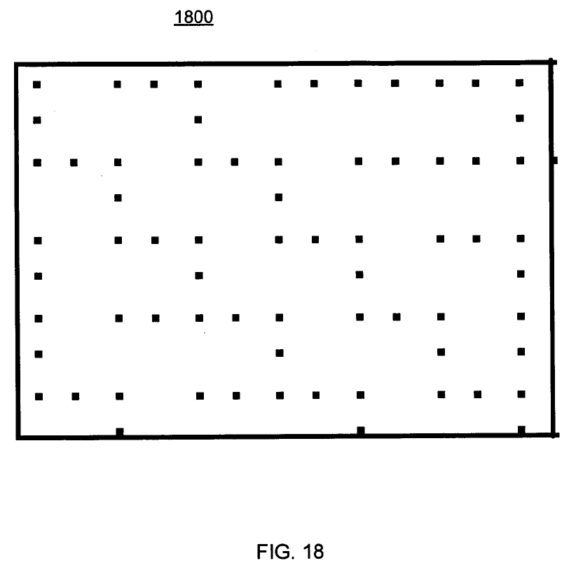

FIG. 17 shows EIC pattern 1700 representing an EIC array with an EIC font as shown in FIG. 14. An EIC pattern is the tiling of EIC symbols by using a specific EIC font to generate a visual representation of EIC array. If a document is printed, the EIC pattern may be printed together with the document content to support the interaction of a digital pen and the printed document.

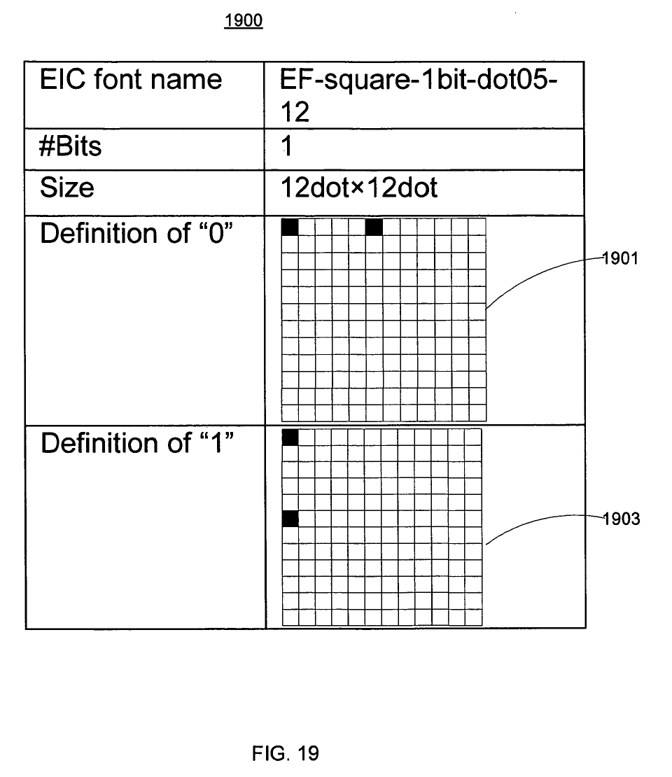

FIG. 18 shows EIC pattern 1800 that represents an EIC array with an EIC font as shown in FIG. 19. The visual effects of an EIC pattern formed by different EIC fonts may appear to be very different (e.g., comparing EIC pattern 1700 with EIC pattern 1800).

FIG. 19 shows EIC 1900 font that encodes one information bit according to an embodiment of the present invention. A “0” is defined by EIC configuration 1901, and a “1” is defined by EIC configuration 1903. The visual effects of an EIC pattern formed by different EIC fonts may appear to be very different. FIG. 18 shows the EIC pattern formed by EIC font 1900 (denoted as EF-square-1 bit-dot05-12) as defined in FIG. 19.

There are numerous choices for EIC fonts that can be used to represent an EIC array with specified dimensions. First, to represent EIC array with K dimensions, an EIC font with K×n bits may be used, where n is any integer. Furthermore, one can design a great number of EIC fonts with specific number of bits. For example, EIC fonts “EF-square-1 bit-solid-12”, “EF-square-1 bit-dashed-12”, and “EF-square-1 bit-dot05-12” may be used to represent 1 bit. One can also design other fonts to represent 1 bit or any other number of bits. (The maximum number of encoded bits is limited by device limitations such as camera resolution and printer resolution.) However, among the huge number of possible EIC fonts, typically only a small subset is suitable for practical use. Some basic considerations are listed in the following discussion.

To decode the embedded x-y position and metadata from a captured EIC pattern (as captured by a camera in the pen), the data in different dimensions is embedded in a “decoupled” way. To achieve this, the number of bits encoded in an EIC font is a multiple of the EIC array dimension. When an EIC symbol is segmented, the bits of one or more complete elements are obtained, and the data in different dimensions can be easily separated. In contrast, this approach may not be efficient. If the data in the same element is represented in multiple symbols, extra efforts for data alignment are needed, i.e., one needs to determine what data in which EIC symbols belong to an element. In other words, for an EIC array with K dimensions, an EIC font with K×n bits may be used, i.e., n elements of EIC array are represented in one EIC symbol. For example, a one dimensional EIC array may use an m bit EIC font, where m is an integer. A two dimensional EIC array may use a 2×m bit EIC font.

Different surfaces may need different EIC fonts because the basic unit for representing information on different surfaces is different. For example, the basic unit of a printed document is a printed dot, whereas the basic unit for surfaces other than paper may not be printed dots. The invention supports different types of displays for displaying an EIC document. As previously discussed, embodiments of the invention present an EIC document in printed form. Other embodiments of the invention present an EIC document on a video display. In such cases, a dot may be a pixel or a group of pixels.

Also, one should consider user usability. For example, to work with a printed document, the EIC pattern should not be too dark to impede reading by a user.

An EIC font is designed as follows with the above considerations.

Simple Geometric Structure

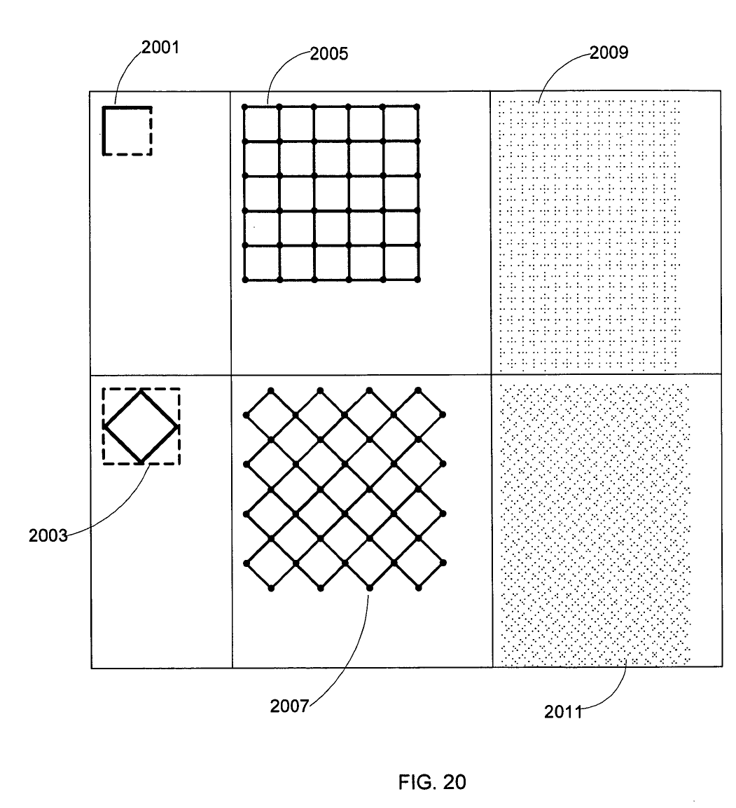

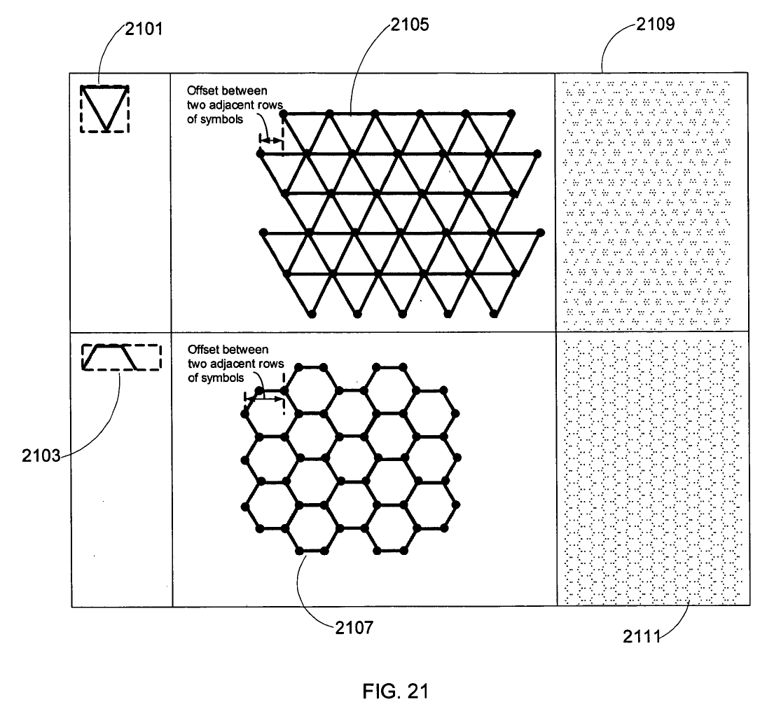

FIG. 20 shows rectangle EIC pattern structure 2005 and diamond EIC pattern structure 2007 according to an embodiment of the present invention. FIG. 21 shows triangle EIC pattern structure 2105 and hexagon EIC pattern structure 2107 according to an embodiment of the present invention. To enable an efficient EIC symbol segmentation algorithm, one may use a geometric shape to design EIC fonts. For example, rectangle (2001), diamond (2003), triangle (2101), and hexagon (2103) shapes are illustrated in FIGS. 20 and 21. In the exemplary embodiment, black dots are configured only on an edge of the shapes. In general, black dots are placed on the vertexes to form the pattern; however, one need not place black dots at each vertex. (In the discussion, a “black dot” indicates that ink is applied on the region, while a “white dot” indicates that ink is not applied on the corresponding region.) The black dots on vertexes are called “clock dots” because clock dots are used to segment the captured EIC symbols.

To make EIC pattern (e.g., EIC patterns 2009, 2011, 2109, and 2111) appear homogeneous, the length of each edge of one EIC font unit is selected to be the same, i.e., using a rotational symmetrical structure. Therefore, one uses a square shape rather than a rectangle shape and an equilateral triangle rather than other triangle types. Since two adjacent symbols share the same edges and vertexes, one assigns the shared edge or vertex to the left and top symbols for convenience. For triangle and hexagon shapes, the two adjacent rows of an EIC symbol should have an offset to form the whole pattern, as shown in FIG. 21. There are several fundamental characteristics in the EIC pattern as shown in FIG. 20. For example, there exist two groups of parallel lines in the EIC pattern formed by square and diamond shape EIC fonts. The two groups of lines are perpendicular to each other. In addition, the distance between the adjacent lines in the same group is equal. Using these fundamental characteristics, one can use efficient algorithms to extract the embedded information from the captured images with rotation, scaling and perspective distortion. For triangle and hexagon pattern, there are three groups of corresponding parallel lines.

Representation of Multiple Bits in One EIC Symbol

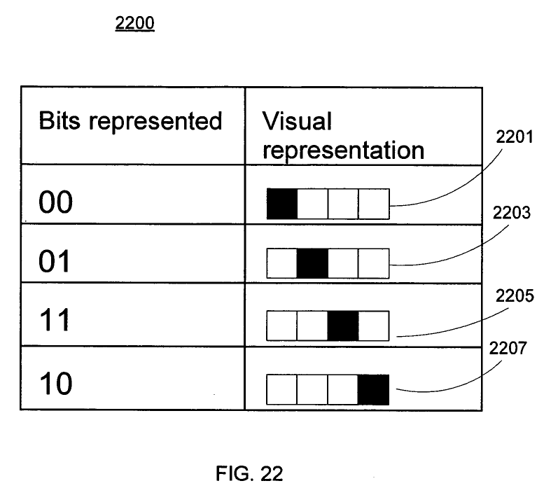

FIG. 22 shows a visual representation of two information bits according to an embodiment of the present invention. The bit representation uses a Gray code so that adjacent bit representations correspond to a change of only one binary digit. A “black dot” in the first position corresponds to “00”; a “black dot” in the second position corresponds to “01”; a “black dot” in the third position corresponds to “11”; and a “black dot” in the fourth position corresponds to “10.” With the Gray code shown in FIG. 22, there cannot be multiple “black dots.”

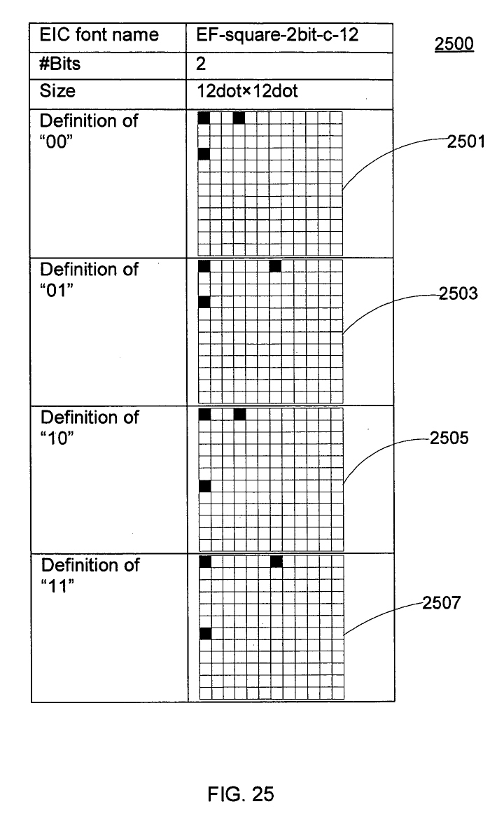

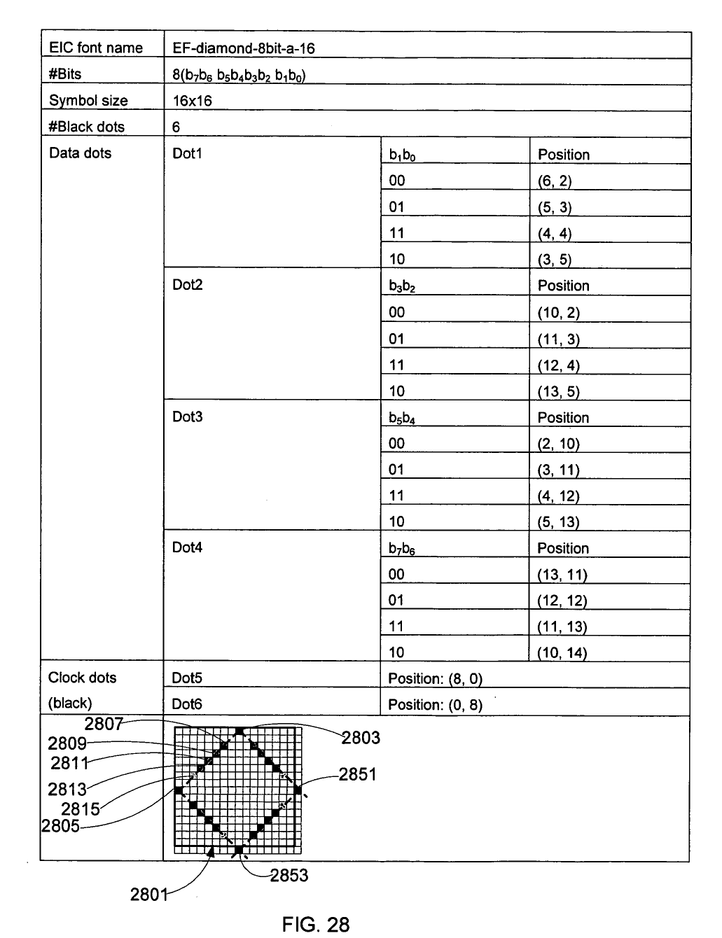

An EIC symbol (font) may represent multiple bits by utilizing multiple dimensions. Each dimension corresponds to an m-array that provides a corresponding bit steam. The bit streams are combined to obtain the EIC data. For example, eight dimensions may be supported by eight m-arrays, where eight bits are encoded in each EIC font. A “black dot” may be related to one or more bits, and thus to one or more m-arrays. For example, the black dots in EIC font EF-Square-1 bit-dot05-12 (shown in FIG. 19) and EF-Square-2 bit-c-12 (shown in FIG. 25) only represent one bit, and are consequently related to one m-array. The one black dot on one edge of EIC font EF-diamond-8 bit-a-16 (shown in FIG. 28) represents two bits (by putting a black dot in one of 4 different positions), and are thus related to 2 m-arrays.

There are several approaches for representing multiple bits in one EIC symbol:

1. Data can be represented by putting black dots in one of the edges of the selected geometric shape. For example, by using square shape, “1” or “0” may be represented by putting black dots on all positions of a vertical/horizontal edge of a symbol. To decrease the darkness, one may put black dots on a uniform portion (e.g., as one half or one third) of the positions of an edge. For example, the two EIC fonts that are shown in FIGS. 14 and 15 use a solid line and a dashed line on an edge to represent 1 bit of information, respectively.

2. Data can also be represented by putting one black dot in different positions as shown in FIG. 22. N bits of information may be encoded by putting a black dot in one of the 2^{N} different positions. For an EIC font in which a basic shape has M edges with J positions in each edge, as many as N bits may be represented, where N is an integer and satisfies 2^{N}≧M×J≧2 ^{N+1}. This method ensures that there is one and only one black dot in these 2^{N} positions. One of the advantages of this approach is that the embedded data can be extracted by comparing the relative gray level of these positions in the captured images. Typically, the position in which the gray level is lowest (darkest) can be estimated as the position where the black dot is placed. The other advantage of this approach is the evenness of intensity of the formed EIC pattern, because whatever data is embedded, the number of black dots in one EIC symbol is the same.

The difference of the data values of adjacent positions should be minimized as much as possible. With this approach, there is only one error bit if there is a small shift between estimated position of darkest dot and the real one. For example, one applies Gray coding (the difference between two adjacent Gray codes is just 1 bit). FIG. 22 is an illustration of representing 2 bits in four positions with Gray coding. Furthermore, one needs to compare the relative gray level of 2^{N} positions to determine the embedded N bits. In order to insure the accuracy of sampling, the distance between these 2^{N} positions and other black dots should be adequately spaced. Other black dots may be clock dots. (In the discussion, note that a “Gray code” refers to a method of coding bits, while a “gray level” refers to the level of darkness of a dot.)

3. Data may also be represented by putting or not putting a black dot in one position of an edge. For an EIC font with M edges and with J positions in each edge, M×J bits of information may be encoded. This approach enables more bits to be encoded in specified size of an EIC symbol than the previous approach. However, there are two disadvantages. First, to determine whether the bit is represented in one position, one needs to determine if the dot is black or not. It may be more difficult than to tell the relative darkness of several dots. Second, the formed EIC pattern may not be uniform. If a bit stream contains a continuous sequence of “0” or “1”, the pattern may be a continuous series of black dots or white dots, which does not appear uniform to the user.

4. A parity check bit may also be represented to detect the error bits from the extracted data under conditions when the quality of captured images is poor. For example, to represent K bits in one symbol, a parity check bit P may be represented as well. The value of P is equal to the binary summation of the K bits to be represented. When these K+1 bits are extracted, one can estimate if error bits occur among K bits by checking if the summation of extracted K bits is equal to the value of extracted parity check bit. The parity check can only detect an odd number of error bits. A parity check bit may not be necessary for an EIC font design if the quality of captured images is adequate.

Orientation Property

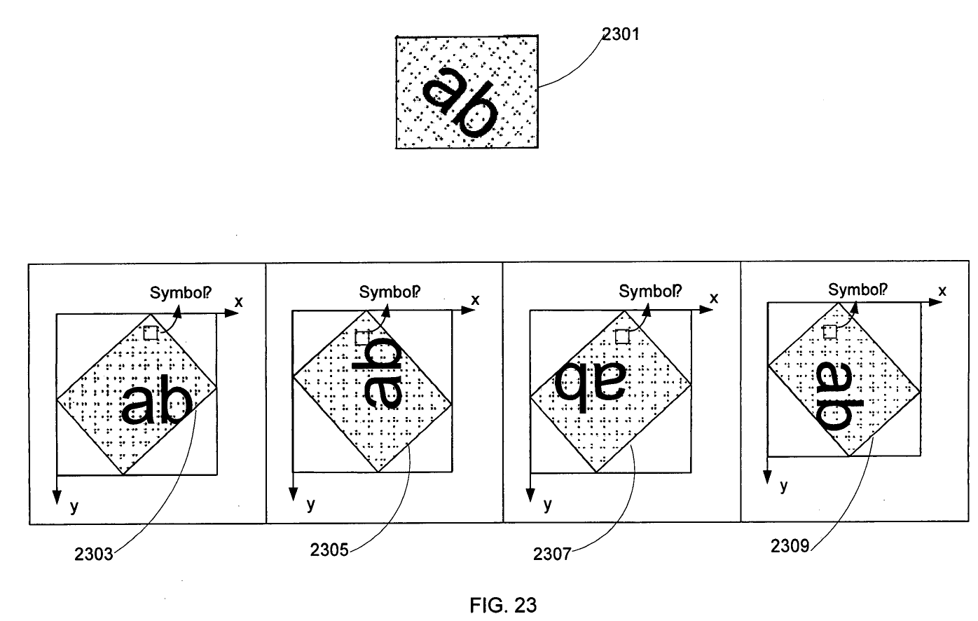

FIG. 23 shows different orientations of captured image 2301 according to an embodiment of the present invention. Since the basic shapes used to form an EIC font are rotational symmetrical, a square or diamond pattern appears similar when it is rotated by 90 degrees (corresponding to 2303), 180 degrees (corresponding to 2305), or 270 degrees (corresponding to 2309) when compared to the correct orientation (corresponding to 2303). Similarly, a triangle or hexagonal pattern appears the same when it is rotated by 60, 120, 180, 240, 300 degrees. To determine the correct orientation, one needs to construct an EIC font that has an “orientation property”, i.e., to ascertain that the distribution of black orientation dots for the correct orientation is different from the distribution of black orientation dots for incorrect orientations. Typically, it is not necessary to determine the correct orientation of a single EIC symbol. It is sufficient if one can determine the correct orientation from the entire EIC pattern of a captured image. For example, one may process the orientation dots for a collection of EIC symbols.

If an EIC font has no orientation property, one can enumerate all possible orientations and extract bits and decode position data and metadata for all possible orientations. Decoding the extracted bits for an incorrect orientation should fail with a large probability. However, the computing cost for determining the correct orientation by decoding may be significant relative to using an EIC font having an-orientation property.

The “orientation property” can be obtained by (a): always putting black dots in several non-rotational symmetrical positions of the symbol or (b): using non-rotational symmetrical positions on the edge to represent data, and keeping selected non-rotational symmetrical positions always white. Actually, approach (b) may be advantageous over approach (a) because the darkness of the whole EIC pattern is not increased. The following examples achieve an “orientation property” with approach (b).

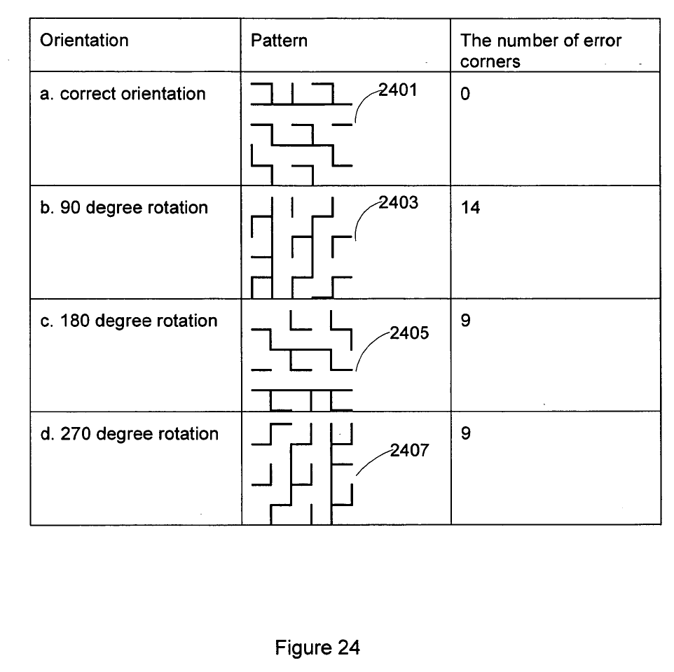

FIG. 24 shows different orientations of an EIC pattern in accordance with an embodiment of the present invention. This example uses EIC font 1400 (“EF-square-1 bit-solid-12”) as defined in FIG. 14. The EIC font uses the first left column and the first top row to represent “0” and “1”. If the EIC symbol is in correct orientation, there is only one black edge between the first left column edge and the first top row edge in one symbol. If the EIC symbol is in wrong orientation, both edges may be white or black. In such a case, an “error corner” occurs. As shown in FIG. 24, by counting the number of “error corners” for patterns 2401, 2403, 2405, and 2407, one can determine the correct orientation by finding the minimum number of “error corners” over the entire EIC pattern.

FIG. 25 shows EIC font 2500 in accordance with an embodiment of the present invention. EIC font 2500, denoted as “EF-square-2 bit-c-12,” is defined in FIG. 25. Four 2-bit combinations are defined: “00” corresponding to configuration 2501, “01” corresponding to configuration 2503, “10” corresponding to configuration 2505, and “11” corresponding to configuration 2507.

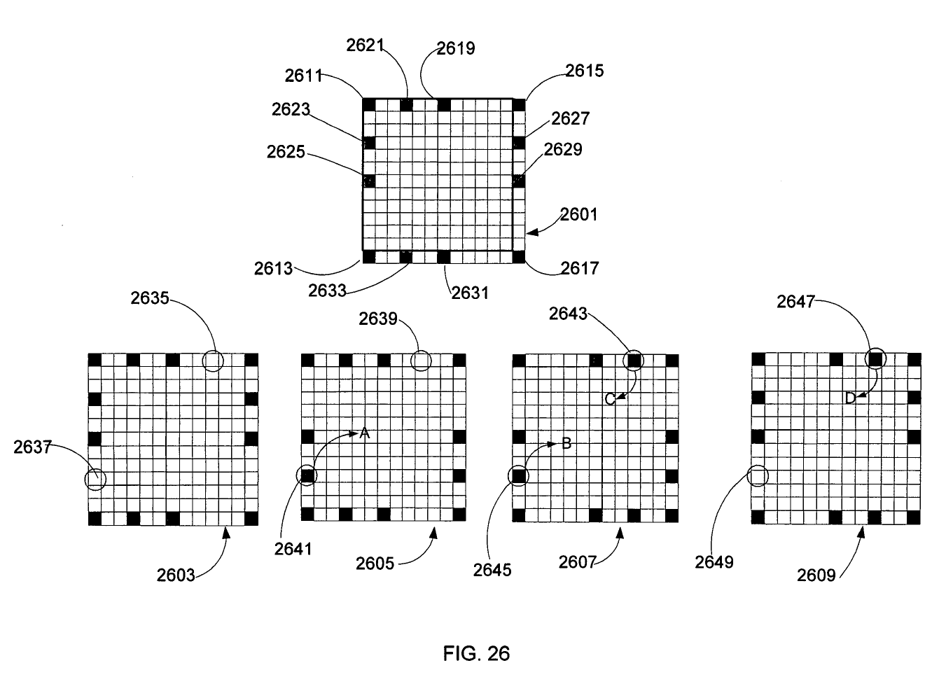

FIG. 26 shows different orientations of EIC font 2500 shown in FIG. 25. FIG. 26 shows an EIC symbol formed by EIC font and its shared edge with an adjacent EIC symbol. One assumes that the probability of a data dot (e.g., dots 2619-2633) being black is 0.5. Clock dots are shown as dots 2611, 2613, 2615, and 2617 and are always marked (black). FIG. 26 shows the EIC symbol without rotation as case 2603. The EIC symbol with rotations of 90 degrees multiples is shown as cases 2605, 2607, and 2609. In order to determine the correct orientation, one inspects orientation dots 2635 and 2637 for case 2603, orientation dots 2639 and 2641 for case 2605, orientation dots 2643 and 2645 for case 2607, and orientation dots 2647 and 2649 for case 2609. One observes that with the correct orientation, both orientation dots are white (unmarked). However, with incorrect orientations, one or both orientation dots may be black. (One observes that there is one and only one black dot between data dots 2619 and 2621, between data dots 2623 and 2625, between 2627 and 2629, and between 2631 and 2633. Therefore, with incorrect orientations, one or both orientation dots may be black.) If one obtains a portion of the EIC pattern, one can count the number of black dots that occurs for the orientation dots in all four possible orientations. One selects the correct orientation by choosing the orientation with the least number of black dots in the orientation dots.

As an example, with an EIC font denoted EF-square-2 bit-c-12, one can calculate the probability that the correct orientation property is selected. One assumes the distribution of “0” and “1” in EIC array as being uniform, i.e., the probability that any binary digit in the element of any position in an EIC array is equal to “0” is 50%, and consequently the probability of “1” is also 50%. This assumption is typically reasonable for an EIC array. Further, one assumes that there are 30 visible EIC symbols in one captured EIC pattern. One EIC symbol with a correct orientation cannot be distinguished from the EIC symbol rotated by 90 degrees in anti-clockwise under the condition that the dot in case 2605 corresponds to orientation dot (2641) being white, which has a probability of 50%. Therefore, the probability that the EIC pattern with 30 EIC symbols in the correct orientation cannot be distinguished from the EIC pattern rotated by 90 degrees in an anti-clockwise direction is (0.5)³⁰=9×10⁻¹⁰, which is a very small value. The probability that the EIC pattern with 30 EIC symbols in the correct orientation cannot be distinguished from the EIC pattern rotated by 270 degrees in an anti-clockwise direction (corresponding to case 2609) is also 9×10⁻¹⁰. Similarly, the probability that the EIC pattern with 30 EIC symbols in correct orientation cannot be distinguished from the EIC pattern rotated by 180 degrees in an anti-clockwise direction (corresponding to case 2607) is (0.25)³⁰=8×10⁻¹⁹, since the probability that both dot positions 2643 and 2645 are white is 0.25. Consequently, the probability that the EIC pattern with 30 EIC symbols in the correct orientation can be distinguished from the EIC pattern rotated by 90, 180 or 270 degrees is: (1−0.5³⁰)×(1−0.25³⁰)×(1−0.5³⁰)=99.9999%.

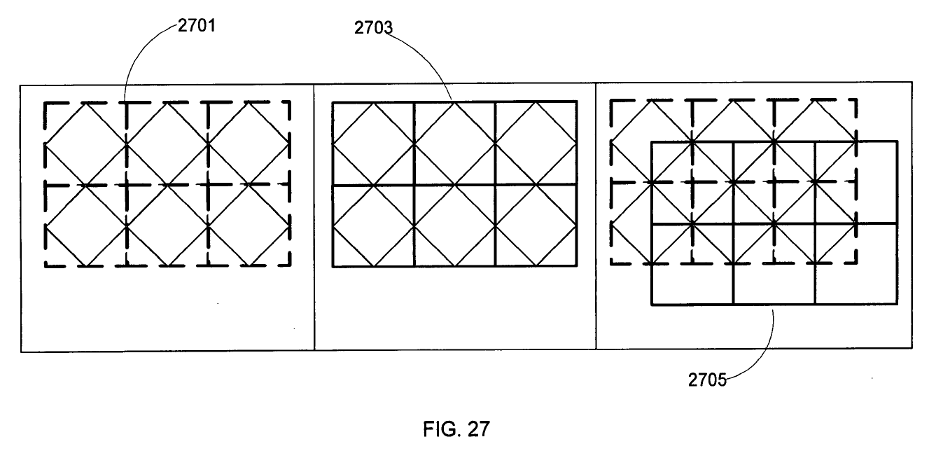

FIG. 27 shows different offsets of a diamond-shaped EIC pattern in accordance with an embodiment of the present invention. For a diamond-shape EIC symbol, not only the correct orientation but also the correct offset should be determined, as illustrated in FIG. 27. Diamond-shaped EIC pattern 2701 shows a tiling of diamond shape EIC symbols. Diamond-shaped EIC pattern 2703 shows EIC symbols that are segmented with the correct offset. Diamond-shaped EIC pattern 2705 shows that EIC symbols may be possibly segmented with a wrong offset. There is not a real EIC symbol in each EIC symbol cell as shown in pattern 2705. Based on this observation, the distribution of black dots with the correct offset should be different than the distribution with the wrong offset. For a diamond-shaped EIC symbol, the design distinguishes the EIC symbol with correct orientation and correct offset from all possible combinations of orientations and offsets, i.e., among 8 possible combinations: 1. correct orientation with correct offset; 2. correct orientation with wrong offset; 3 and 4. rotation by 90 degrees with 2 possible offsets; 5 and 6. rotation by 180 degrees with 2 possible offsets; and 7 and 8. rotation by 270 degrees with 2 possible offsets.

FIG. 28 shows diamond shaped EIC font 2801 in accordance with an embodiment of the present invention. FIG. 28 defines EIC font 2801 that is denoted as EIC font EF-diamond-8 bit-a-16. EIC font includes clock dots 2803 and 2803, data dots 2807-2813 (corresponding to bits b1 and b2), other data dots (not labeled) on the other three edges, orientation dot 2813, and other orientation dots (not labeled) on the other three edges. Clock dots 2851 and 2853 are associated with adjacent EIC symbols.

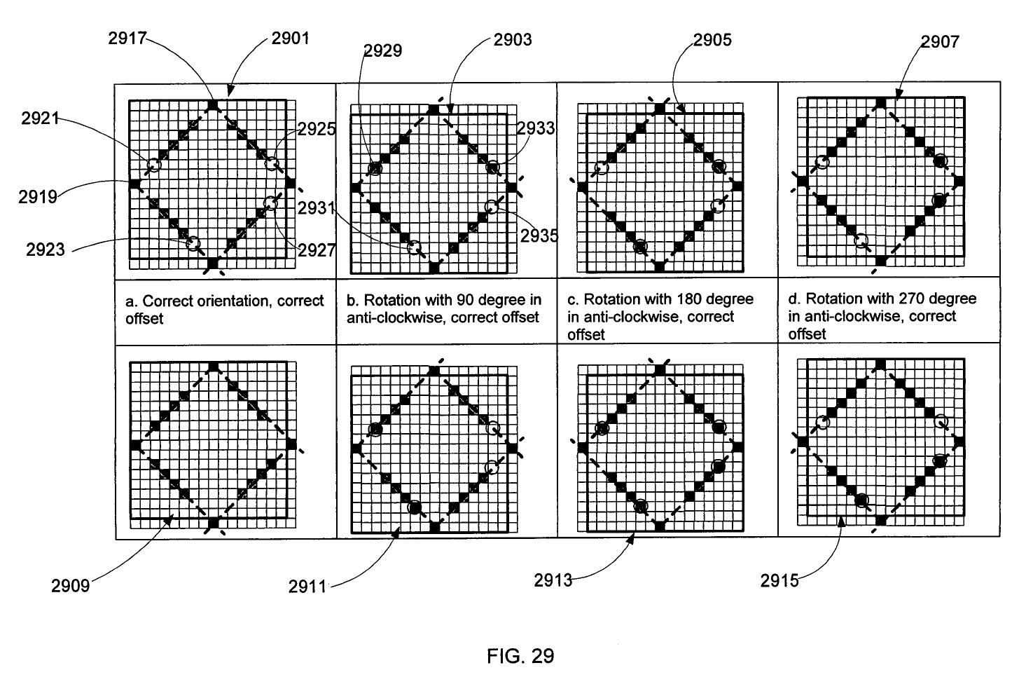

FIG. 29 shows different orientations (2901, 2903, 2905, 2907, 2909, 2911, 2913, and 2915) of EIC font 2801 shown in FIG. 28. The orientation dots are identified by the dots that are circled. For example, with the correct orientation 2901, orientation dots 2921-2927 are white dots (i.e., no ink is printed in those dot regions). However, with incorrect orientation 2903, even though orientation dots 2931 and 2935 are white dots, orientation dots 2929 and 2933 are black dots. As shown in FIG. 29, only with the correct orientation and correct offset, are all of the orientation dots white (not inked). Otherwise, some of the orientation dots may be black dots (inked). Consequently, by counting the number of black dots in all eight possible orientation and offset cases, one can select the orientation and offset with the least number of black dots in the orientation dots as the estimate of the correct orientation and offset.

For other shaped EIC symbols, one can design EIC fonts with an orientation property in a similar way.

Sample EIC Fonts

Additional EIC fonts may be designed in a similar way as with the previously discussed EIC fonts.

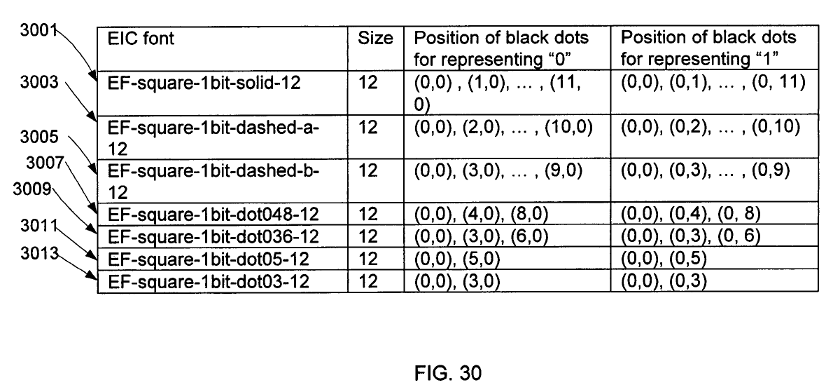

FIG. 30 shows seven different EIC fonts that encode one information bit according to an embodiment of the present invention. Each EIC font (3001, 3003, 3005, 3007, 3009, 3011, and 3013) occupies a square region of 12 by 12 dots. EIC font 3001 was previously discussed with FIG. 14, and EIC font 3003 was previously discussed with FIG. 15. Each EIC font is defined in terms of coordinate system 1600 as shown in FIG. 16.

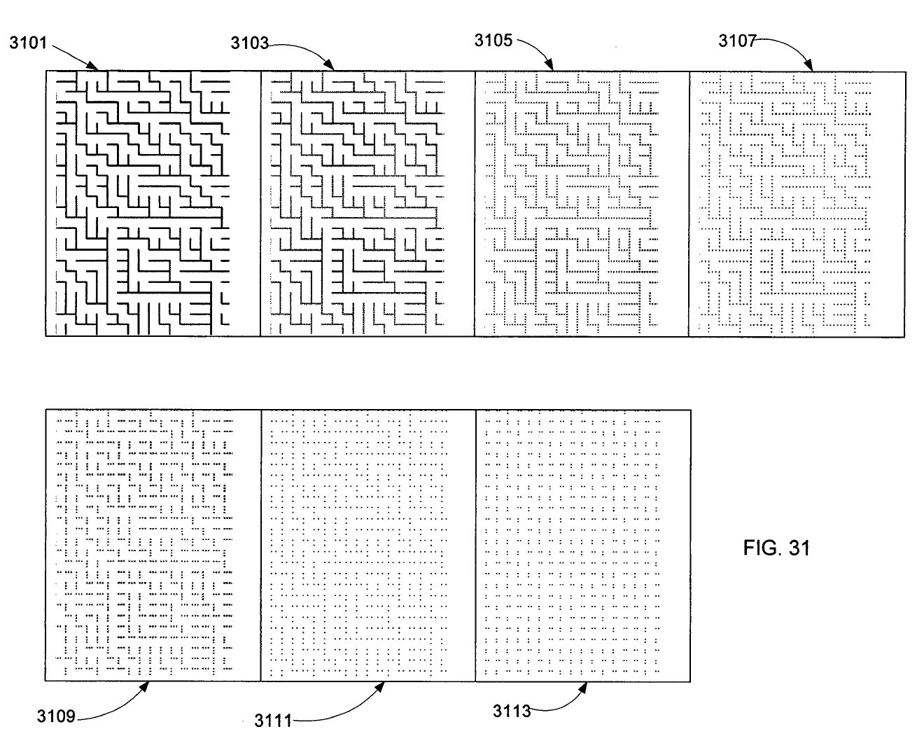

FIG. 31 shows corresponding EIC patterns for the EIC fonts shown in FIG. 30. EIC patterns 3101, 3103, 3105, 3107, 3109, 3111, and 3113 correspond to EIC fonts 3001, 3003, 3005, 3007, 3009, 3011, and 3013, respectively. For all 1 bit EIC fonts, by decreasing the number of used black dots, the formed EIC pattern become less dark.

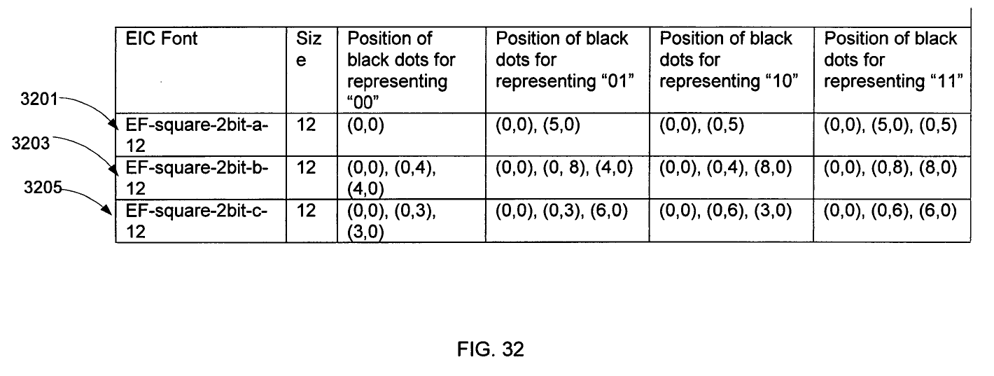

FIG. 32 shows different EIC fonts that encode two information bits according to an embodiment of the present invention. Each EIC font 3201, 3203, and 3203) occupies a square of 12 dots by 12 dots. Different combinations of dots are specified for different combinations of information bits.

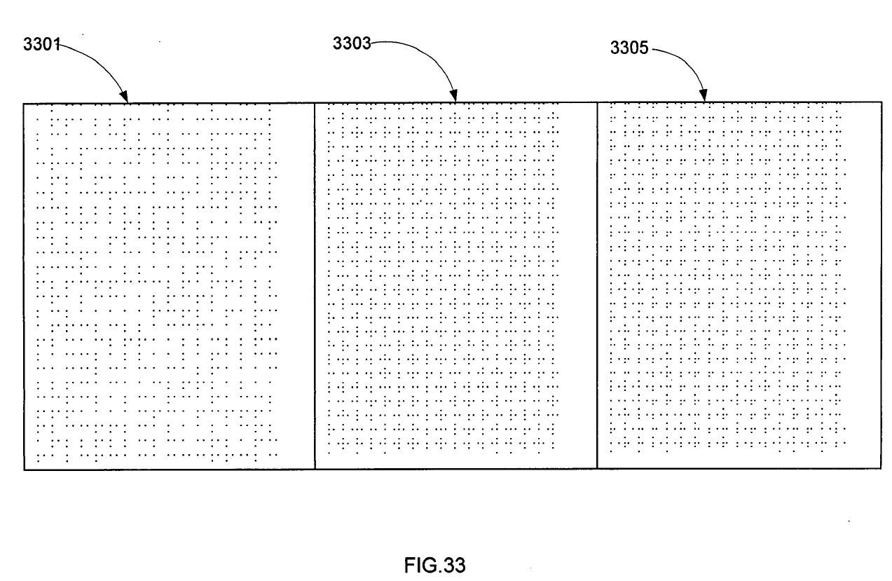

FIG. 33 shows corresponding EIC patterns for the EIC fonts shown in FIG. 32. EIC patterns 3301, 3303, and 3305 correspond to EIC fonts 3201, 3203, and 3205.

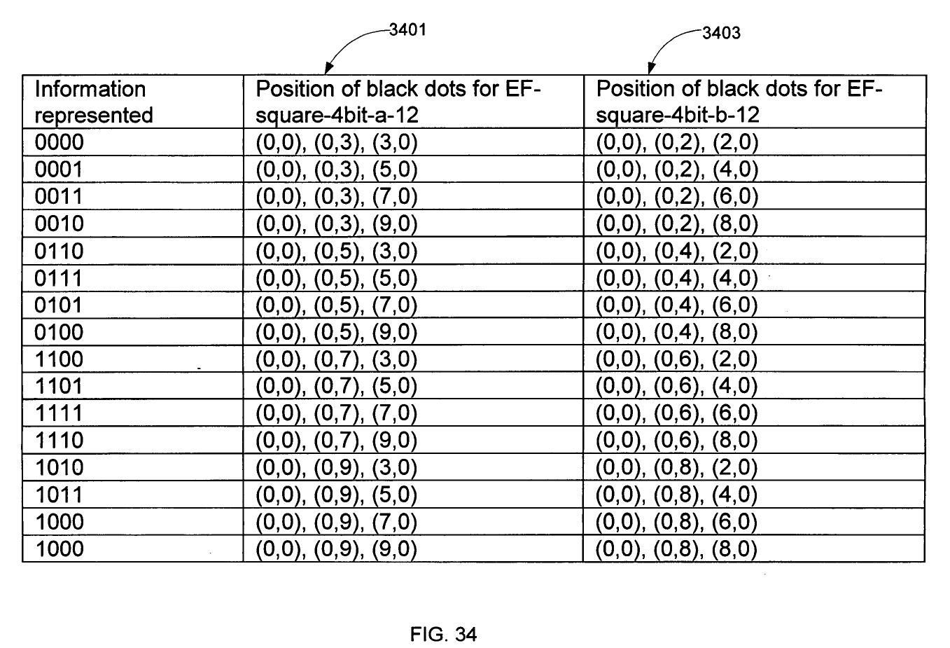

FIG. 34 shows different EIC fonts that encode four information bits according to an embodiment of the present invention. As with the EIC fonts defined in FIGS. 30 and 32, each 4-bit EIC font 3401 and 3403 occupies a square region of 12 dots by 12 dots.

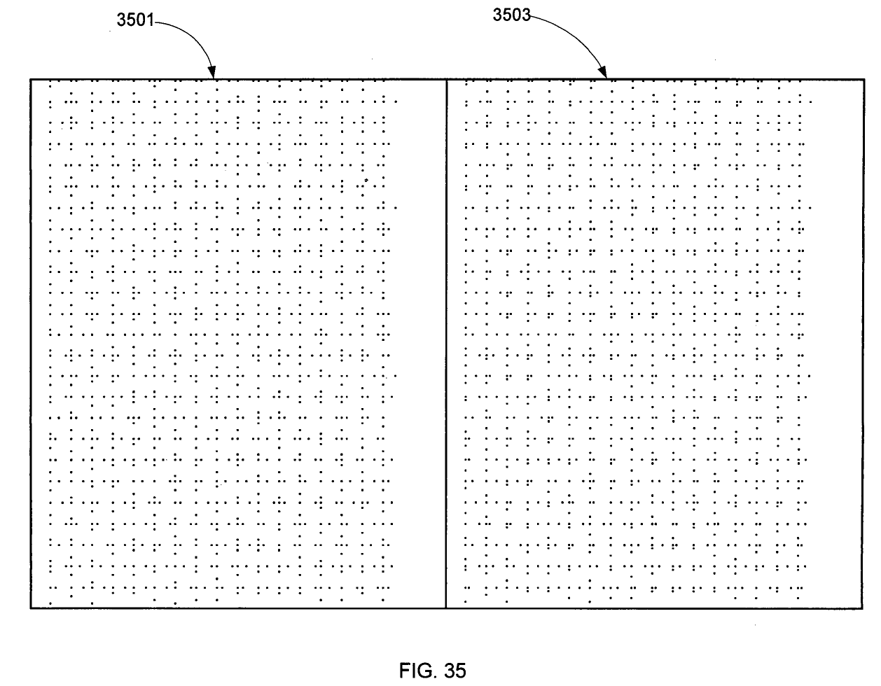

FIG. 35 shows corresponding EIC patterns for the EIC fonts shown in FIG. 34. EIC patterns 3501 and 3503 correspond to EIC fonts 3401 and 3403.

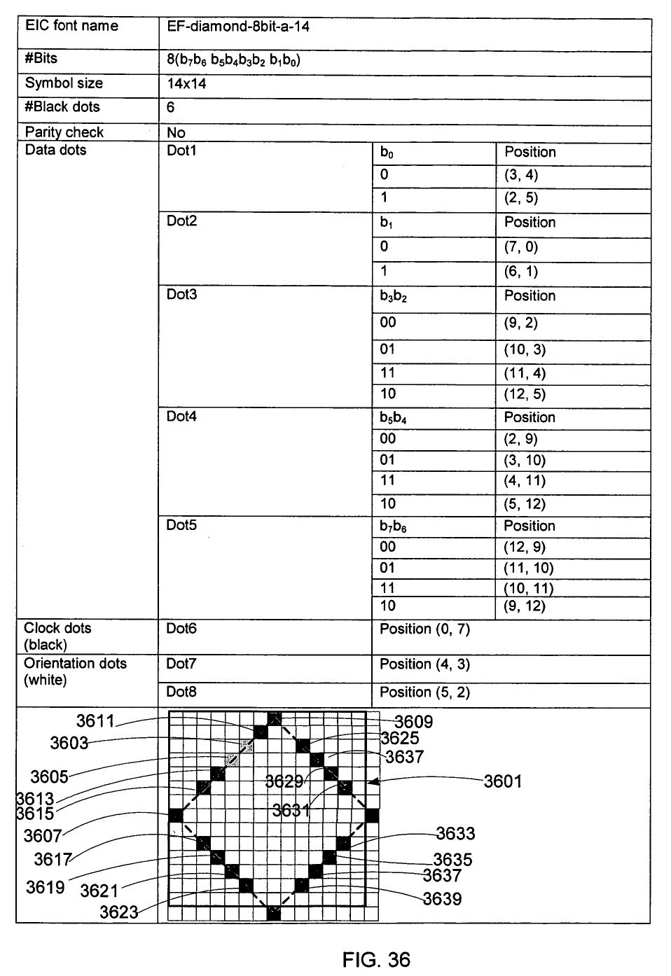

FIG. 36 shows diamond-shaped EIC font 3601 that encodes eight information bits according to an embodiment of the present invention. Clock dot 3607 is associated with EIC font 3601. Dots 3603 and 3605 are configured as orientation dots. Dots 3609-3639 are configured as data (information) dots.

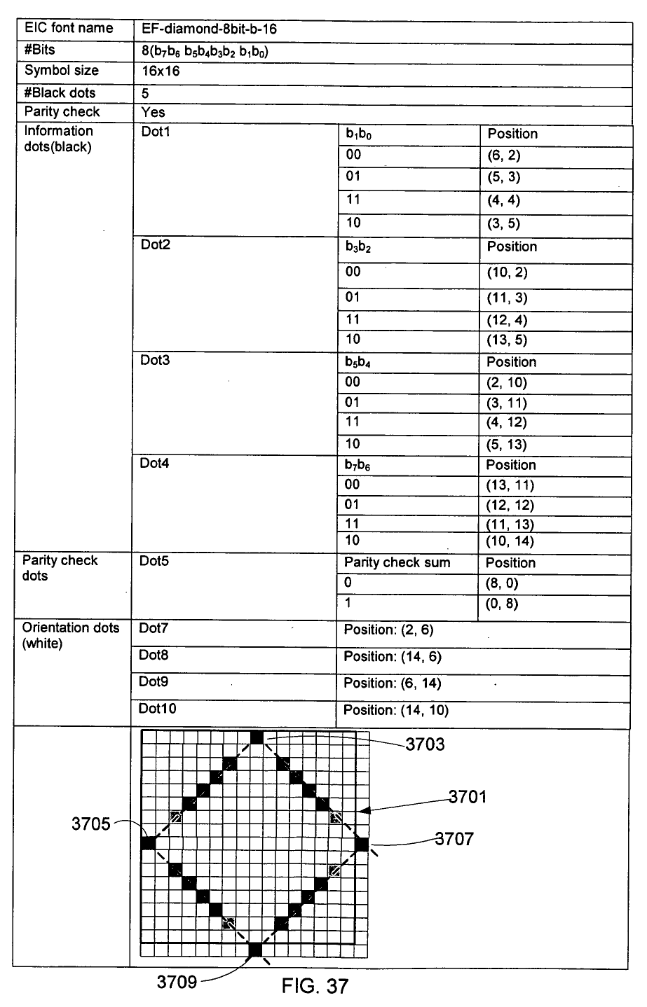

FIG. 37 shows diamond-shaped EIC font 3701 that encodes eight information bits with a parity check bit according to an embodiment of the present invention. The parity check bit is determined by parity dots 3703 and 3705. If the parity check bit is “0”, then parity check dot 3703 is a black dot (inked) and parity check dot 3705 is a white dot (i.e., not inked). If the parity check bit is “1”, then parity check dot 3705 is a black dot and parity check dot 3703 is a white dot. Both parity check dots are not inked for the same EIC font. Parity check dots 3707 and 3709 are associated with adjacent EIC fonts. The parity check dots also assist in segmenting the captured EIC symbol. Consequently, clock dots are not configured with EIC font 3701 for the embodiment.

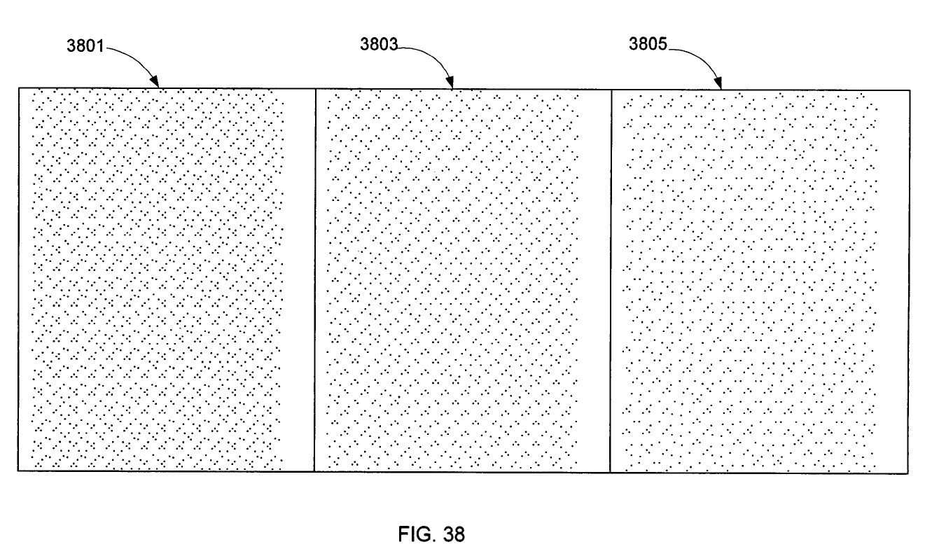

FIG. 38 shows corresponding EIC patterns for the EIC fonts shown in FIG. 36 and 37. EIC pattern 3801 corresponds to EIC font 3601 and EIC pattern 3805 corresponds to EIC font 3701. EIC pattern 3803 corresponds to EIC font EF-diamond-8 bit-a-16 (not shown).

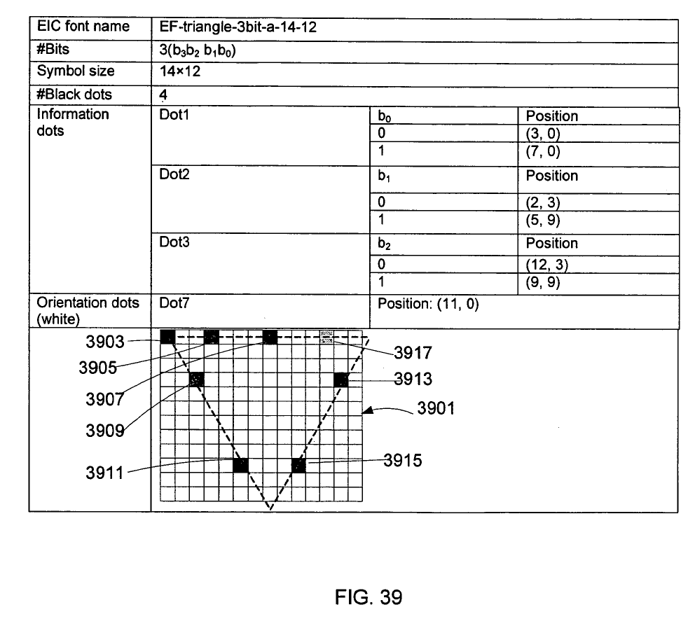

FIG. 39 shows triangle-shaped EIC font 3901 that represents three information bits according to an embodiment of the present invention. Dot 3903 functions as a clock dot, dot 3917 functions as an orientation dot, and dots 3905-3915 function as data dots.

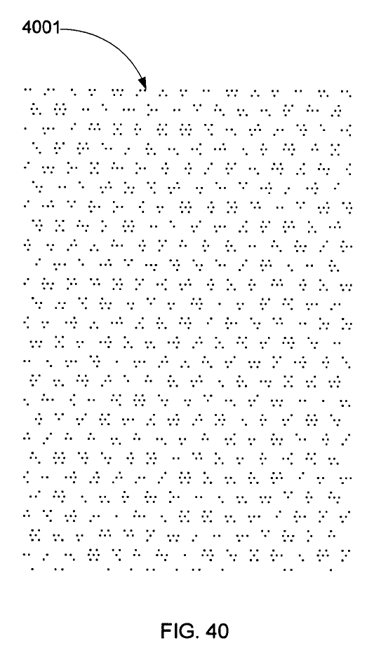

FIG. 40 shows corresponding EIC pattern 4001 that corresponds to EIC font 3901 as shown in FIG. 39.

Process for Designing EIC Font

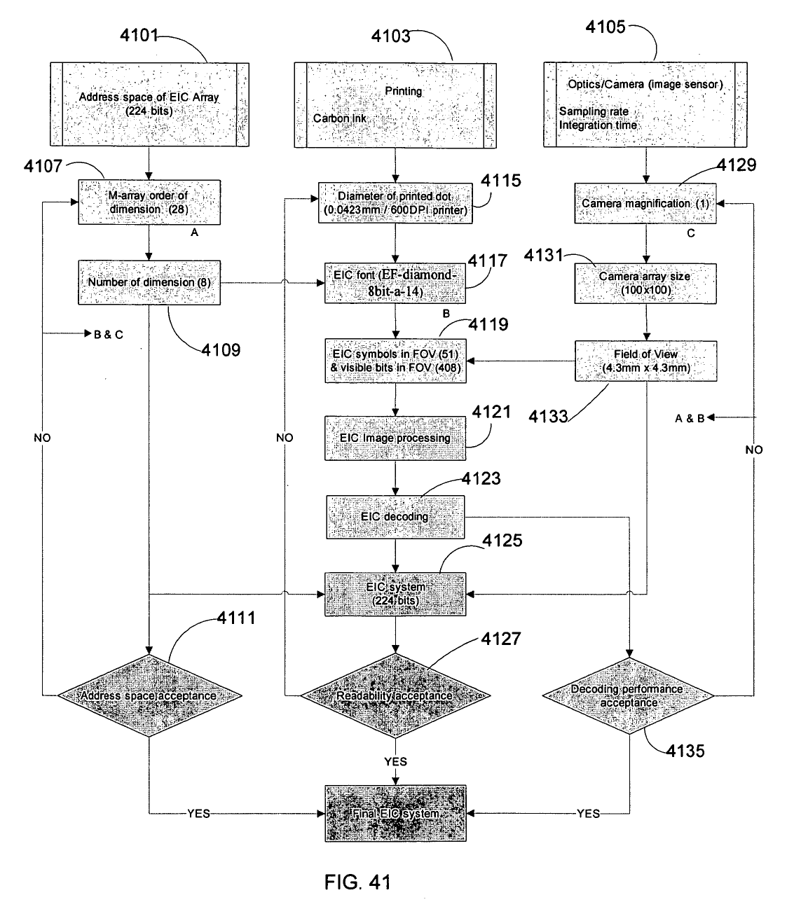

FIG. 41 shows flow diagram 4100 for designing an EIC document system in accordance with an embodiment of the invention. Typically, with an EIC document system, the design of an EIC font should be considered together with the design of other system components, including the address space of EIC array (corresponding to system component 4101), EIC pattern printing (corresponding to system component 4103), and the image capturing pen device (corresponding to system component 4105). Design considerations include the printer characteristics, as determined by step 4115, and the pen characteristics, as determined by steps 4129-4133. The camera magnification may affect the decoding performance. If the camera magnification is not sufficient, for example, two adjacent data dot 3617 and 3619 shown in FIG. 36 may be mapped into one image pixel. Then one cannot distinguish which dot is a black dot between dots 3617 and 3619; consequently, the correct bit cannot be recognized. On the other hand, if the magnification is too large, to insure that the same EIC array bits are decodable, one needs a larger image sensor array size in order to capture enough bits for decoding, thus increasing the system complexity (i.e., the data to be processed is increased). The design goal of the whole system includes three aspects: large enough address space, a fast enough processing speed, and visual acceptance of EIC patterns when printed on paper. The parameters of an exemplary EIC document system are also shown within brackets as shown in FIG. 41. Process 4100 is completed when the EIC document system in step 4125 satisfies the desired address space (corresponding to step 4111), the desired readability (corresponding to step 4127), and the desired decoding performance (corresponding to step 4135).

The address space of an EIC array is corresponds to the summation of the m-array order of each dimension. The address space is an important index of the capability of an EIC document system. A larger address space may generate a bigger area of EIC patterns (given the same EIC symbol size), thus covering more document pages.

To achieve a large system address space, one may use EIC array with multiple dimensions, and multiple bits EIC font. The m-array order is determined by step 4107. As previously discussed, each m-array corresponds to a dimension. Each bit encoded by an EIC font corresponds to a dimension. One reason for using a multiple dimensional EIC array is to reduce the algorithmic complexity of m-array decoding with error bits. The algorithmic complexity is proportional to m³, where m is m-array order. A very large m-array order results in the decoding time cost being very large. For example, for a 224-bit EIC document system, one can use an eight-dimensional EIC array with eight m-arrays of order 28. With the example, the complexity measure of decoding for the example is 8 times 28³. If one uses a four-dimensional EIC array with four m-arrays of order 56, the complexity measure is 4 times 56³, which is much larger than the first EIC configuration. The number of dimensions is determined by step 4109. Therefore, the exemplary embodiment uses the first EIC configuration, which corresponds to 8-bit EIC font 3601 (corresponding to EF-diamond-8 bit-a-14 EIC font as shown in FIG. 36).

In the exemplary embodiment, the EIC document system is designed to obtain 224 usable (decodable) bits in a camera image. Other exemplary embodiments may be designed for a different number of bits per camera image using process 4100.

To insure that the captured EIC pattern images generated by a specific EIC array is decodable, a large enough camera array size and field of view (FOV) is required as determined by steps 4129, 4131, 4133, 4119, 4121, 4123, and 4135. The number of bits in the FOV determines the order of the m-array that can be decoded. For an m-array with the order of N, the number of bits in the FOV must be larger than N. For example, with an eight-dimensional EIC font, as discussed above, each m-array requires at least 28 bits per camera image. Consequently, the minimum total number of bits per camera image for decoding is 224 bits (28*8).

In order to ascertain that the EIC document system functions robustly, document occlusion should also be considered because document content printed by carbon ink may occlude the EIC pattern. For example, for an m-array with order 224, if one assumes 50% occlusion, then one typically designs a camera system that provides 448 visible bits in an area without occlusion.

EIC image processing and decoding should be efficient and effective. EIC font design should enable EIC image processing and decoding to overcome challenges posed by the application, namely, a document pen (e.g., a digital pen that works with printed documents). Design factors include:
1. Non-uniform illumination: in the real world, the distribution of illumination is non-uniform.
2. Aliasing: images captured by low resolution camera are usually aliased because of under-sampling. In aliased images, the same EIC pattern looks different at different rotation angles of the pen. This is a much smaller problem for a high resolution camera.
3. Rotation, scale and perspective: images captured are usually rotated, scaled (may be differently along the X and Y axis) and transformed by perspective due to pen rotation and tilting.
4. EIC pattern occluded by document content: many EIC symbols are occluded by document content. The number of EIC symbols captured is thus decreased.

A simple geometry structure and orientation property of an EIC font ensures the efficiency of EIC image processing. On the other hand, a multiple bit EIC font design improves the decoding efficiency greatly as previously discussed.

Process 4100 typically uses a square-shaped EIC font (e.g., EIC font 2001 shown in FIG. 20) or diamond-shaped EIC font (EIC font 2003) because the EIC patterns for square-shaped and diamond-shaped EIC fonts are simpler than triangle-shaped and hexagon-shaped fonts. Consequently, the image processing is typically more efficient with square-shaped and diamond-shaped EIC fonts. There are two available edges with a square-shaped EIC font and four available edges with a diamond-shaped EIC font. If one represents the same number of bits on one edge, then a diamond-shaped EIC font may represent more bits in one symbol. Therefore, to represent 1, 2 or 4 bits in one EIC symbol, a square-shaped EIC font is typically selected. To represent 8 or more bits, a diamond-shaped EIC font is typically selected.

Visual appearance of an EIC pattern is important from a usability point of view since one prints an EIC pattern with documents. An EIC pattern should be aesthetically pleasing and not degrade the reading experience. Typically, the legibleness (of EIC patterns at reading distance), evenness, and darkness affect subjective evaluation and preference of the EIC font. Typically, the less legible, the more even, and the lighter the EIC pattern, the better.

There may be different ways to print EIC patterns, for example invisible ink. With the advancement of printing technology, particularly with the introduction of cheaper invisible ink (invisible to the human eye but visible to pen camera), EIC patterns may be printed with the invisible ink on printed document or printed books. This may significantly increase the usability and utility of a digital pen.

To support EIC printing with a different DPI, one may maintain the size of EIC symbol. For example, if one prints an EIC font EF-8 bit-a-16 with a 600 DPI-printer, the physical size of a EIC symbol is 0.677 mm×0.677 mm (=16*25.4 mm/600). To print the EIC pattern with same size using a 1200 DPI-printer, one uses 2×2 black dots to simulate one black dot with 600 DPI-printer. Thus, the size of an EIC symbol is approximately the same with that printed with 600 DPI-printer.

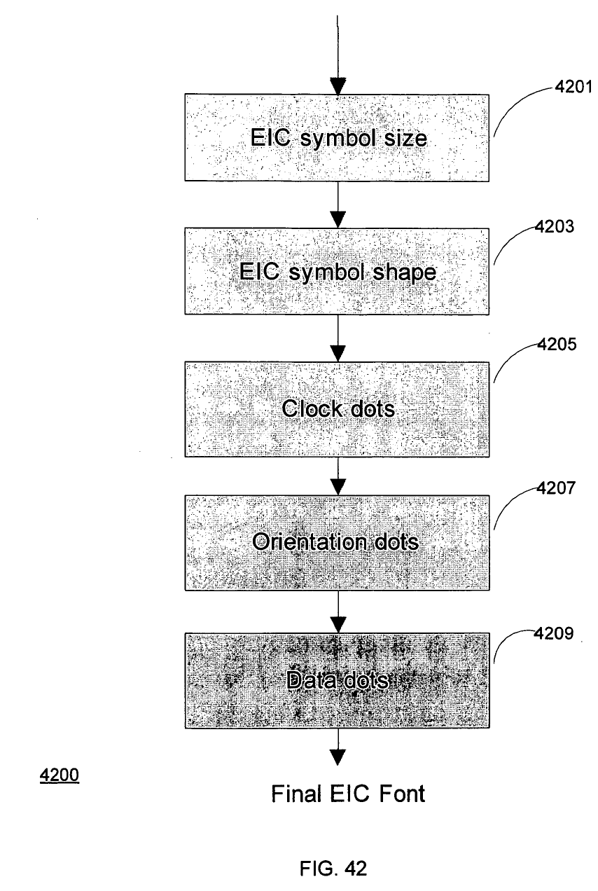

FIG. 42 shows process 4200 for designing an EIC font in accordance with an embodiment of the invention. Process 4200 corresponds to step 4117 as shown in FIG. 41. From the printing and the pen characteristics, step 4201 determines the EIC symbol size. (When determining the EIC symbol size, the document content occlusion is an important factor that affects the selection of EIC symbol size. If the EIC symbol size is too small, many EIC symbols may be occluded by text in a general document (e.g., a paragraph of text with Arial font and 12 pound font size). Thus, the distribution of visible EIC symbol will be nonuniform, in which there may be substantially less visible EIC symbols in the document content area than in a blank area. In contrast, if the EIC symbol size is appropriate, one may assume a 50% occlusion rate in a typical document. If the EIC symbol is too large, one may need a larger FOV for the same EIC array order to capture enough bits for decoding, thus increasing the complexity of optical design.) For example, as previously discussed, the EIC font may be constructed from 12 dots by 12 dots (corresponding to coordinate system 1600 as shown in FIG. 16). In step 4203, the EIC symbol shape is selected in order to obtain the desired number of bits in a camera image. In step 4205, the EIC font may be configured with clock bits (e.g. dots 2611-2617 as shown in FIG. 26) in order to segment the captured EIC symbols. In order to properly orientate the EIC symbol, orientation dots are configured in step 4207: As previously discussed, orientation dots (e.g., dots 2635 and 2637) remain white regardless of the EIC data. In step 4209, data dots (e.g., dots 2619-2633) are marked so that the EIC symbol encodes the desired EIC data.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the invention has been defined using the appended claims, these claims are illustrative in that the invention is intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part, of the invention. It may be intended that the written description of the invention contained herein covers all such modifications and alterations.

We claim:

1. A computer-readable medium for configuring an embedded interaction code (EIC) document system and having computer-executable instructions to perform the steps comprising:
(a) determining an address space of an EIC array, the EIC array including at least one m-array;
(b) estimating a size of an EIC symbol from a characteristic of a display device and document contents;
(c) in response to (a) and (b), selecting a geometric shape for the EIC symbol; and
(d) configuring an EIC font to represent the EIC symbol by including at least one data dot that is located on an edge of the EIC font.

2. The computer-readable medium of claim 1, containing further computer-executable instructions for:
(e) determining whether decoding performance satisfies a performance criterion.

3. The computer-readable medium of claim 2, containing further computer-executable instructions for:
(f) in response to (e), repeating (a), (b), (c), and (d).

4. The computer-readable medium of claim 1, containing further computer-executable instructions for:
(e) determining whether the address space satisfies a performance criterion.

5. The computer-readable medium of claim 4, containing further computer-executable instructions for:
(f) in response to (e), repeating (a), (b), (c), and (d).

6. The computer-readable medium of claim 1, containing further computer-executable instructions for:
(e) in response to (d), receiving an indication whether an EIC pattern is visually acceptable when printed on paper.

7. The computer-readable medium of claim 6, containing further computer-executable instructions for:
(f) if the EIC pattern is not acceptable, repeating (c)-(d).

8. The computer-readable medium of claim 1, containing further computer-executable instructions for:
(a)(i) determining a number of dimensions of the EIC array.

9. The computer-readable medium of claim 8, containing further computer-executable instructions for:
(a)(ii) increasing the number of dimensions of the EIC array to reduce a complexity measure of constituent m-arrays decoding.

10. The computer-readable medium of claim 2, containing further computer-executable instructions for:
(f) configuring the EIC font to take an expected number of occluded EIC symbols in the camera image into account.

11. A computer-readable medium for selecting an embedded interaction code (EIC) font and having computer-executable instructions to perform the steps comprising:
(a) estimating a size of an EIC symbol;
(b) selecting a geometric shape for the EIC font, the geometric shape supporting a determined number of dimensions for an EIC array;
(c) configuring the EIC font with a least one data dot to support the determined number of dimensions and with the selected geometric shape; and
(d) generating the EIC symbol using the EIC font.

12. The computer-readable medium of claim 11, containing further computer-executable instructions for:
(e) configuring the EIC font with at least one clock dot for segmenting the EIC symbol.

13. The computer-readable medium of claim 11, containing further computer-executable instructions for:
(e) configuring the EIC font with one parity check dot.

14. The computer-readable medium of claim 11, containing further computer-executable instructions for:
(e) configuring the EIC font with at least one orientation dot, the at least one orientation dot being unused for conveying information bits.

15. The computer-readable medium of claim 11, containing further computer-executable instructions for:
(e) configuring a plurality of data dots along an edge of the EIC font, wherein the plurality of data dots are mapped to a plurality of information bits using a Gray code.

16. The computer-readable medium of claim 15, containing further computer-executable instructions for:
(f) encoding the plurality of information bits in the EIC symbol by marking only one of the plurality of data dots.

17. A computer-readable medium for processing an embedded interaction code (EIC) symbol that is included in an EIC document and that is captured in a camera image, the computer-readable medium having computer-executable instructions to perform the steps comprising:
(a) obtaining the camera image that contains the EIC symbol;
(b) segmenting the EIC symbol to distinguish the EIC symbol from other EIC symbols; and
(c) properly orientating the EIC symbol from at least one orientation dot.

18. The computer-readable medium of claim 17, containing further computer-executable instructions for:
(c)(i) analyzing a plurality of EIC symbols from the EIC document;
(c)(ii) determining a number of orientation dots that are marked;
(c)(iii) rotating the EIC symbols and repeating (c)(i) and (c)(ii); and
(c)(iv) selecting a rotational position corresponding to a least number of orientation dots that are marked.

19. The computer-readable medium of claim 17, containing further computer-executable instructions for:
(d) extracting one parity dot; and
(e) determining whether a parity of the EIC symbol is correct.

20. The computer-readable medium of claim 17, containing further computer-executable instructions for:
(d) determining an offset of an EIC pattern that includes the EIC symbol.
